(19) United States
(12) Patent Application Publication
(10) Pub. No.: US 2026/0189899 A1
(43) Pub. Date: Jul. 2, 2026

(54) METHOD, APPARATUS AND SYSTEM FOR SEMANTIC COMMUNICATIONS

(71) Applicant: Huawei Tecchnologies Co., Ltd., Shenzhen (CN)

(72) Inventors: Mengyao Ma, Shenzhen (CN); Yiqun Ge, Ottawa (CA); Jianglei Ma, Ottawa (CA); Qifan Zhang, Kanata (CA)

(21) Appl. No.: 19/425,649

(22) Filed: Dec. 18, 2025

Related U.S. Application Data
(63) Continuation of application No. PCT/CN2023/128887, filed on Oct. 31, 2023.
(60) Provisional application No. 63/509,426, filed on Jun. 21, 2023.

(51) Int. Cl. H04W 8/24

(52) U.S. Cl. CPC H04W 8/24

(57) ABSTRACT

Provided are a method, apparatus and system for semantic communications. A first device such as a sensing device can send a first message that includes semantic capability information of the first device, so that a second device, such as a central device, can obtain the semantic capability information and send a second message to the first device based on the semantic capability information of the first device.

### CROSS-REFERENCE TO RELATED APPLICATIONS

This application is continuation of International Application No. PCT/CN2023/128887, filed on Oct. 31, 2023, which claims priority to U.S. Provisional Ser. No. 63/509,426 , filed on Jun. 21, 2023, applications of which are hereby incorporated by reference in their entirety.

### TECHNICAL FIELD

The present disclosure relates to the field of semantic communication technologies and, in particular, to a method for semantic communications, an apparatus and a system.

### BACKGROUND

A sensing function will be integrated into the 6th generation (6G) system. A large number of the sensing user equipments (UEs) or sensing devices will be densely deployed in cities, factories, farms and so on. In addition to mobile phones, sensing devices will become an important type of UEs or devices that claim an arrival of IoT time.

Like internet searching engines, 6G will come up with the counterpart, an internet of thing (IoT) searching engine, in a true physical world. In fact, billions of IoT-based applications such as driverless cars, automation factories, smart cities, and autonomous farms, will heavily depend on an efficient and real-time searching engine in our physical world.

Recently, artificial intelligence (AI) has conquered various intellectual and cognitive domains. Some AI is exploring the cutting edge of our intellectual knowledge in chemistry, gaming, mathematics, gene engineering; some other AI is providing a human-level Q&A platform in the digital world; the domain that AI has not conquered is real-time physical world. Physical-world AI, in which AI technologies are to penetrate into all the aspects of our society and life, may be built on omnipresent IoT connections thanks to 6G.

More challenging than internet searching engine, real-world searching engine would have to search the physical world in real time over a large scale of physical areas and to deal with a multitude of types of data and information (some may be novel and some may not have been invented yet). Furthermore, green technology, low-energy and low-emission, are also raised as key feature of 6G. A sensing device may be battery powered and/or completely powered by solar and wind. It would be costly and impracticable to ask all the sensing devices in a large scale to feedback what they are sensing at the same time. On one hand, the frequent sensing and transmission consumes a sensing device much energy and reduces their battery life time; on other hand, such a high density of the IoT deployment may block the uplink channels, especially the uplink (UL) bandwidth is more expensive than the downlink (DL) one.

This background information is provided to reveal information believed by the applicant to be of possible relevance to the present disclosure. No admission is necessarily intended, nor should it be construed, that any of the preceding information constitutes prior art against the present disclosure.

### SUMMARY

In a first aspect, the present disclosure provides a method for semantic communications, which includes:
sending a first message, where the first message includes semantic capability information of a first device; and
obtaining a second message sent based on the semantic capability information of the first device.

Because the obtained second message is sent based on the semantic capability information of the first device, messages beyond the semantic capability of the first device would not be obtained, thereby improving the efficiency of semantic communications and also saving communication resources.

In a possible implementation of the first aspect, the semantic capability information indicates semantic related capability information or token related capability information.

In a possible implementation of the first aspect, the semantic capability information indicates at least one of the following: whether a semantic capability is supported or not; a number of task types supported; a number of modality types supported; a query semantic level supported; a query semantic length supported; a query token level supported; a query token length supported; a sensing token length supported; a semantic model supported; a tokenization model supported; a tokenization function supported; or, a scoring function supported, where the scoring function is used to score a relevance of a piece of sensed data and/or a relevance of a sensing semantic.

Because the semantic capability information indicates at least one of the above, the device to which the first message is sent can know the semantic capability of the first device and send the second messages according to the semantic capability of the first device, and thus, the second messages to the first device can be sent in a targeted manner.

In a possible implementation of the first aspect, the semantic capability information includes a flag or one-bit indication indicating whether the first device supports the semantic capability or not.

Because the semantic capability information includes the flag or the one-bit indication, the device to which the first message is sent can know whether the first device supports the semantic capability or not easily through the flag or indication, and will not send a message for semantic communication to the first device if the first device does not support the semantic capability, thereby saving communication resources.

In a possible implementation of the first aspect, the semantic capability information includes at least one task identifier and/or at least one modality identifier, where each of the at least one task identifier indicates one task type supported by the first device, and each of the at least one modality identifier indicates one modality type supported by the first device.

Because the semantic capability information includes at least one task identifier each of which indicates one task type supported by the first device and/or at least one modality identifier each of which indicates one modality type supported by the first device, the device to which the first message is sent can know the task type and/or the modality type supported by the first device, and can send a message to the first device based on the task type and/or the modality type supported by the first device.

In a possible implementation of the first aspect, the at least one task identifier and/or the at least one modality identifier is obtained from broadcast configuration of a second device.

In a possible implementation of the first aspect, the at least one task identifier or the at least one modality identifier is carried in a synchronization signal and physical broadcast channel block (SSB) or a system information block (SIB).

Because the at least one task identifier and/or the at least one modality identifier can be obtained through broadcast configuration of the second device, e.g., it can be carried in a SSB or a SIB, thus flexible configuration of identifiers can be achieved. The first device can inform another device of the task type supported by the first device and/or the modality type supported by the first device through semantic capability information including the at least one task identifier and/or the at least one modality identifier.

In a possible implementation of the first aspect, the at least one task identifier or the at least one modality identifier is pre-configured.

Because the at least one task identifier or the at least one modality identifier is pre-configured, thus the resources for transmission of the identifiers can be saved. The first device can inform another device of the task type supported by the first device and/or the modality type supported by the first device through semantic capability information including the at least one task identifier and/or the at least one modality identifier.

In a possible implementation of the first aspect, the sending the first message includes: sending the first message in a sequence.

When the first message is sent in a sequence, since the sequence is normally easy to generate and process, there may be less requirements on the processing capability or computing resources of the device sending the first message and the device receiving the first message.

In a possible implementation of the first aspect, the sending the first message includes: sending the first message based on carrier aggregation.

Because the first message may be sent based on carrier aggregation, a device to which the first message is sent can receive the capability information based on carrier aggregation, thus the transmission efficiency can be improved.

In a possible implementation of the first aspect, the semantic capability information is semantized or tokenized.

Because the semantic capability information is semantized or tokenized, the resources required for sending the first message including the semantic capability information may be saved.

In a possible implementation of the first aspect, the obtaining the second message sent based on the semantic capability information of the first device includes: obtaining a piece of query-related information multicast or unicast based on the semantic capability information of the first device.

In a possible implementation of the first aspect, the piece of query-related information includes at least one query semantic and/or at least one query token.

In a possible implementation of the first aspect, a task type and/or a modality type for each of the at least one query semantic or for each of the at least one query token is supported by the first device.

In a possible implementation of the first aspect, a query semantic level for each of the at least one query semantic or a query token level for each of the at least one query token is supported by the first device.

In a possible implementation of the first aspect, a query semantic length for each of the at least one query semantic or a query token length for each of the at least one query token is supported by the first device.

Because the obtained query-related information multicast or unicast based on the semantic capability information of the first device includes at least one query semantic and/or at least one query token whose task type and/or modality type, query semantic level or query semantic length is supported by the first device, which means, the obtained query semantic and/or query token is supported by the first device in terms of task/modality type, query semantic level, or query semantic length, then query semantics and/or query tokens beyond the semantic capability of the first device would not be obtained by the first device, thereby improving communication efficiency and saving communication resources.

In a possible implementation of the first aspect, after the obtaining the second message sent based on the semantic capability information of the first device, the method further includes: sending a sensing result, where the sensing result includes at least one piece of sensed data and/or at least one sensing semantic.

A sensing result including sensed data and/or sensing semantic may be sent after the second message is obtained, thereby providing a response to the query semantic and/or query token in the query-related information.

In a possible implementation of the first aspect, a score of relevance of each piece of the at least one piece of sensed data is higher than a first threshold; and/or, a score of relevance of each of the at least one sensing semantic is higher than a second threshold.

Because a score of relevance of each piece of the at least one piece of sensed data and/or a score of relevance of each of the at least one sensing semantic is higher than a threshold, it can be ensured that only relevant sensed data and/or sensing semantic would be sent, thereby saving communication resources.

In a possible implementation of the first aspect, the piece of query-related information includes at least one semantization model configuration, and the at least one semantization model configuration is supported by the first device; or, the piece of query-related information includes a semantization model configuration update, and the semantization model configuration update includes update information for the first device to update at least one outdated semantization model configuration to at least one updated semantization model configuration respectively, and the at least one updated semantization model configuration is supported by the first device.

Because the obtained query-related information multicast or unicast based on the semantic capability information of the first device includes at least one semantization model configuration that is supported by the first device, or includes a semantization model configuration update which includes update information for the first device to update at least one outdated semantization model configuration to at least one updated semantization model configuration that is supported by the first device, thus only the semantization model configuration or the updated semantization model configuration supported by the first device can be obtained, and those semantization model configurations that are not supported by the first device can be avoided, thereby saving communication resources.

In a possible implementation of the first aspect, the piece of query-related information includes at least one approach for tokenization, and the at least one approach for tokenization is supported by the first device.

In a possible implementation of the first aspect, each of the at least one approach for tokenization includes a tokenization model or a tokenization function.

Because the obtained query-related information multicast or unicast based on the semantic capability information of the first device includes at least one approach for tokenization that is supported by the first device, it ensures the availability of the approach for tokenization, e.g., the tokenization model or tokenization function, and avoids those approaches for tokenization that cannot be supported by the first device, thereby saving communication resources.

In a possible implementation of the first aspect, the piece of query-related information includes at least one scoring function, and the at least one scoring function is supported by the first device.

Because the obtained query-related information multicast or unicast based on the semantic capability information of the first device includes at least one scoring function that is supported by the first device, it ensures the availability of the scoring function, while avoiding those scoring functions not supported by the first device, thereby saving communication resources.

In a possible implementation of the first aspect, the obtaining the second message sent based on the semantic capability information of the first device includes: obtaining the second message which is intended for a group of first devices that have same or qualified semantic capability, where the group of first devices includes the first device.

Because the second message is intended for a group of first devices that have same or qualified semantic capability, relative to broadcasting the message to all the devices, communication is more effective, and power saving of devices can be achieved.

In a possible implementation of the first aspect, the second message includes paging information.

Because the paging information is intended for a group of first devices that have same or qualified semantic capability, relative to broadcasting the paging information to all the devices, communication is more effective, and power saving of devices can be achieved.

In a possible implementation of the first aspect, the first device is a sensing device.

In a second aspect, the present disclosure provides a method for semantic communications, which includes:
obtaining at least one first message, where each of the at least one first message includes semantic capability information of a respective one first device of at least one first device; and
sending at least one second message based on the semantic capability information of at least one third device included in the at least one first device.

Because the second message is sent based on the semantic capability information of at least one third device included in the at least one first device, the second message will only be sent to those devices supporting corresponding semantic capability, improving the efficiency of semantic communications and also saving communication resources.

In a possible implementation of the second aspect, the semantic capability information indicates semantic related capability information or token related capability information.

In a possible implementation of the second aspect, the semantic capability information indicates at least one of the following: whether a semantic capability is supported or not; a number of task types supported; a number of modality types supported; a query semantic level supported; a query semantic length supported; a query token level supported; a query token length supported; a sensing token length supported; a semantic model supported; a tokenization model supported; a tokenization function supported; or, a scoring function supported, where the scoring function is used to score a relevance of a piece of sensed data and/or a relevance of a sensing semantic.

Because the semantic capability information indicates at least one of the above, after obtaining the first message including the semantic capability information, the semantic capability of the first device from which the first message is obtained can be known, and the second messages according to the semantic capability of the third device can be sent, and thus, the second messages to the third device can be sent in a targeted manner.

In a possible implementation of the second aspect, the semantic capability information includes a flag or one-bit indication indicating whether a first device from which a first message including the semantic capability information is obtained supports the semantic capability or not.

Because the semantic capability information includes the flag or the one-bit indication, after obtaining the first message including the semantic capability information, whether the first device supports the semantic capability or not can be known easily through the flag or indication, and if the first device does not support the semantic capability, a message for semantic communication will not be sent to the first device, thereby saving communication resources.

In a possible implementation of the second aspect, the semantic capability information includes at least one task identifier and/or at least one modality identifier, where each of the at least one task identifier indicates one task type supported by a first device from which a first message including the semantic capability information is obtained, and each of the at least one modality identifier indicates one modality type supported by the first device from which the first message including the semantic capability information is obtained.

Because the semantic capability information includes at least one task identifier each of which indicates one task type supported by the first device and/or at least one modality identifier each of which indicates one modality type supported by the first device, the device obtaining the first message including the semantic capability information can know the task type and/or the modality type supported by the first device, and can send a message to the first device based on the task type and/or the modality type supported by the first device.

In a possible implementation of the second aspect, the at least one task identifier and/or the at least one modality identifier is obtained from broadcast configuration of a second device.

In a possible implementation of the second aspect, the at least one task identifier or the at least one modality identifier is carried in a synchronization signal and physical broadcast channel block (SSB) or a system information block (SIB).

The at least one task identifier and/or the at least one modality identifier can be obtained through broadcast configuration of the second device, e.g., it can be carried in a SSB or a SIB, thus flexible configuration of identifiers can be achieved. A first device from which the first message is obtained can inform another device the task type supported by the first device and/or the modality type supported by the first device through semantic capability information including the at least one task identifier and/or the at least one modality identifier.

In a possible implementation of the second aspect, the at least one task identifier or the at least one modality identifier is pre-configured.

The at least one task identifier or the at least one modality identifier is pre-configured, thus resources for transmission of the identifiers can be saved. A first device from which the first message is obtained can inform another device the task type supported by the first device and/or the modality type supported by the first device through semantic capability information including the at least one task identifier and/or the at least one modality identifier.

In a possible implementation of the second aspect, the obtaining the at least one first message includes: obtaining the at least one first message in a sequence.

When the first message is obtained in a sequence, since the sequence is normally easy to process, there may be less requirements on the processing capability or computing resources of the device sending the first message and the device receiving the first message.

In a possible implementation of the second aspect, the obtaining the at least one first message includes: obtaining the at least one first message sent based on carrier aggregation.

The at least one first message is obtained based on carrier aggregation, thus the transmission efficiency can be improved.

In a possible implementation of the second aspect, the semantic capability information is semantized or tokenized.

Because the semantic capability information is semantized or tokenized, the resources required for transmission of the semantic capability information is saved.

In a possible implementation of the second aspect, the sending the at least one second message based on the semantic capability information of the at least one third device included in the at least one first device includes: multicasting or unicasting at least one piece of query-related information based on the semantic capability information of the at least one third device.

In a possible implementation of the second aspect, each piece of query-related information of the at least one piece of query-related information includes at least one query semantic and/or at least one query token.

In a possible implementation of the second aspect, a task type and/or a modality type for each of the at least one query semantic or for each of the at least one query token is supported by a third device to which the each piece of query-related information is multicast or unicast.

In a possible implementation of the second aspect, a query semantic level for each of the at least one query semantic or a query token level for each of the at least one query token is supported by a third device to which the each piece of query-related information is multicast or unicast.

In a possible implementation of the second aspect, a query semantic length for each of the at least one query semantic or a query token length for each of the at least one query token is supported by a third device to which the each piece of query-related information is multicast or unicast.

Because the query-related information multicast or unicast based on the semantic capability information of the third device includes at least one query semantic and/or at least one query token whose task type and/or modality type, query semantic level or query semantic length is supported by the third device, which means, the multicast or unicast query semantic and/or query token is supported by the third device in terms of task/modality type, query semantic level, or query semantic length, then query semantics and/or query tokens beyond the semantic capability of the third device would not be sent to the third device, thereby improving communication efficiency and saving communication resources.

In a possible implementation of the second aspect, after the sending the at least one second message based on the semantic capability information of the at least one third device included in the at least one first device, the method further includes: obtaining a sensing result, where the sensing result includes at least one piece of sensed data and/or at least one sensing semantic.

A sensing result including sensed data and/or sensing semantic may be obtained after the second message is sent, and the sensing result provides a response to the query semantic and/or query token in the query-related information.

In a possible implementation of the second aspect, a score of relevance of each piece of the at least one piece of sensed data is higher than a first threshold; and/or, a score of relevance of each of the at least one sensing semantic is higher than a second threshold.

Because a score of relevance of each piece of the at least one piece of sensed data and/or a score of relevance of each of the at least one sensing semantic is higher than a threshold, it can be ensured that only relevant sensed data and/or sensing semantic would be sent, thereby saving communication resources.

In a possible implementation of the second aspect, each piece of query-related information of the at least one piece of query-related information includes at least one semantization model configuration, and the at least one semantization model configuration is supported by a third device to which the each piece of query-related information is multicast or unicast; or, each piece of query-related information of the at least one piece of query-related information includes a semantization model configuration update, and the semantization model configuration update includes update information for a third device to which the each piece of query-related information is multicast or unicast to update at least one outdated semantization model configuration to at least one updated semantization model configuration respectively, and the at least one updated semantization model configuration is supported by the third device to which the each piece of query-related information is multicast or unicast.

Because the query-related information multicast or unicast based on the semantic capability information of the third device includes at least one semantization model configuration that is supported by the third device, or includes a semantization model configuration update which includes update information for the third device to update at least one outdated semantization model configuration to at least one updated semantization model configuration that is supported by the third device, thus only the semantization model configuration or the updated semantization model configuration supported by the third device can be obtained, and those semantization model configurations that are not supported by the third device can be avoided, thereby saving communication resources.

In a possible implementation of the second aspect, each piece of query-related information of the at least one piece of query-related information includes at least one approach for tokenization, and the at least one approach for tokenization is supported by a third device to which the each piece of query-related information is multicast or unicast.

In a possible implementation of the second aspect, each of the at least one approach for tokenization includes a tokenization model or a tokenization function.

Because the query-related information multicast or unicast based on the semantic capability information of the third device includes at least one approach for tokenization that is supported by the third device, it ensures the availability of the approach for tokenization, e.g., the tokenization model or tokenization function, and avoids those approaches for tokenization that cannot be supported by the third device, thereby saving communication resources.

In a possible implementation of the second aspect, each piece of query-related information of the at least one piece of query-related information includes at least one scoring function, and the at least one scoring function is supported by a third device to which the each piece of query-related information is multicast or unicast.

Because the query-related information multicast or unicast based on the semantic capability information of the third device includes at least one scoring function that is supported by the third device, it ensures the availability of the scoring function, while avoiding those scoring functions not supported by the third device, thereby saving communication resources.

In a possible implementation of the second aspect, the sending the at least one second message based on the semantic capability information of the at least one third device included in the at least one first device includes: sending the at least one second message which is intended for a group of sensing devices that have same or qualified semantic capability, where the group of sensing devices includes the at least one third device.

Because the second message is intended for a group of sensing devices that have same or qualified semantic capability, relative to broadcasting the message to all the devices, communication is more effective, and power saving of devices can be achieved.

In a possible implementation of the second aspect, the at least one second message includes paging information.

Because the paging information is intended for a group of sensing devices that have same or qualified semantic capability, relative to broadcasting the paging information to all the devices, communication is more effective, and power saving of devices can be achieved.

In a possible implementation of the second aspect, the first device is a sensing device.

In a third aspect, the present disclosure provides a first apparatus, which includes various modules configured to execute the method for semantic communications according to the first aspect or any implementation of the first aspect.

In a fourth aspect, the present disclosure provides a second apparatus, which includes various modules configured to execute the method for semantic communications according to the second aspect or any implementation of the second aspect.

In a fifth aspect, the present disclosure provides a third apparatus, which includes a processing circuitry for executing the method for semantic communications according to the first aspect or any implementation of the first aspect.

In a sixth aspect, the present disclosure provides a fourth apparatus, which includes a processing circuitry for executing the method for semantic communications according to the second aspect or any implementation of the second aspect.

In a seventh aspect, the present disclosure provides a wireless communication system, which includes: at least one first apparatus according to the third aspect or any implementation of the third aspect or at least one third apparatus according to the fifth aspect; at least one second apparatus according to the fourth aspect or any implementation of the fourth aspect or at least one fourth apparatus according to the sixth aspect; and at least one fifth apparatus, where each of the at least one fifth apparatus includes: a sending module configured to send at least one query message to the at least one second apparatus; and an obtaining module configured to obtain at least one fused sensing result sent by the at least one second apparatus, where the at least one fused sensing result is generated based on one or more sensing results.

In an eighth aspect, the present disclosure provides a wireless communication system, which includes: a first processing circuitry for executing the method for semantic communications according to the first aspect or any implementation of the first aspect; a second processing circuitry for executing the method for semantic communications according to the second aspect or any implementation of the second aspect; and a third processing circuitry for executing following steps: sending at least one query message to the second processing circuitry; and obtaining at least one fused sensing result sent by the second processing circuitry, where the at least one fused sensing result is generated based on one or more first sensing results.

In a ninth aspect, the present disclosure provides a computer-readable medium storing computer execution instructions which, when executed by a processor, cause the processor to execute the method for semantic communications according to the first aspect or any implementation of the first aspect or the second aspect or any implementation of the second aspect.

In a tenth aspect, the present disclosure provides a computer program product including computer execution instructions which, when executed by a processor, cause the processor to execute the method for semantic communications according to the first aspect or any implementation of the first aspect or the second aspect or any implementation of the second aspect.

The present disclosure provides a method for semantic communications, an apparatus, and a system, where the method for semantic communications includes sending a first message which includes semantic capability information of a first device and obtaining a second message sent based on the semantic capability information of the first device. Because the obtained second message is sent based on the semantic capability information of the first device, those messages beyond the semantic capability of the first device would not be obtained, thereby, improving the efficiency of semantic communications and also saving communication resources.

### BRIEF DESCRIPTION OF DRAWINGS

Reference will now be made, by way of example, to the accompanying drawings which show example embodiments of the present disclosure, and in which:

FIG. 1 is a simplified schematic illustration of a communication system according to one or more example embodiments of the present disclosure.

FIG. 2 is a schematic illustration of an example communication system according to one or more example embodiments of the present disclosure.

FIG. 3 is a schematic illustration of a basic component structure of a communication system according to one or more example embodiments of the present disclosure.

FIG. 4 is a block diagram of a device in a communication system according to one or more example embodiments of the present disclosure.

FIG. 5 is a schematic illustration of a semantic communication scenario according to one or more example embodiments of the present disclosure.

FIG. 6 is a schematic illustration of a plurality of the sensing devices in a semantic communication scenario according to one or more example embodiments of the present disclosure.

FIG. 7 is a schematic illustration of interaction among devices in a semantic communication scenario according to one or more example embodiments of the present disclosure.

FIG. 8 is another schematic illustration of interaction among devices in a semantic communication scenario according to one or more example embodiments of the present disclosure.

FIG. 9 is a schematic flowchart of a method for semantic communications according to one or more example embodiments of the present disclosure.

FIG. 10 is another schematic flowchart of a method for semantic communications according to one or more example embodiments of the present disclosure.

FIG. 11 is a schematic illustration of realizing a chain of thoughts according to one or more example embodiments of the present disclosure.

FIG. 12 is another schematic illustration of interaction among devices in a semantic communication scenario according to one or more example embodiments of the present disclosure.

FIG. 13 is another schematic illustration of interaction among devices in a semantic communication scenario according to one or more example embodiments of the present disclosure.

FIG. 14 is a schematic illustration of generating a query message.

FIG. 15 is a schematic illustration of reversing a semantic.

FIG. 16 is a schematic illustration of tokenizing a query semantic into a query token.

FIG. 17 is a schematic illustration of responding to a query token.

FIG. 18 is a schematic illustration of scoring the relevance with tokens.

FIG. 19 is another schematic illustration of responding to a query token.

FIG. 20 is a schematic illustration of scoring a relevance with semantic.

FIG. 21 is another schematic illustration of responding to a query token.

FIG. 22 is a schematic illustration of scoring the relevance with tokens converted from semantics.

FIG. 23 is a schematic illustration of generating query tokens.

FIG. 24 is a schematic illustration of generating query semantics.

FIG. 25 is a schematic illustration of responding to two queries with a common semantization model and two tokenization models.

FIG. 26 is a schematic illustration of responding to two queries with a common semantization model and a common tokenization model.

FIG. 27 is another schematic illustration of responding to two queries with two semantization models and two tokenization models.

FIG. 28 is another schematic illustration of responding to two queries with two semantization models and a common tokenization model.

FIG. 29 is a schematic illustration of responding to two query semantics with a common semantization model and two different tokenization models.

FIG. 30 is a schematic illustration of responding to two query semantics with a common semantization model and a common tokenization model.

FIG. 31 is a schematic illustration of responding to two query semantics with two semantization models and two tokenization models.

FIG. 32 is a schematic illustration of responding to two query semantics with two semantization models and one tokenization model.

FIG. 33 is a schematic illustration of responding to two query semantics with one semantization model without tokenization model.

FIG. 34 is a schematic illustration of responding to two query semantics with two semantization models without tokenization model.

FIG. 35 is a schematic illustration of processing two sensing semantics independently.

FIG. 36 is a schematic illustration of processing one sensing semantic but with two tasks independently.

FIG. 37 is a schematic structural diagram of a first apparatus according to one or more example embodiments of the present disclosure.

FIG. 38 is a schematic structural diagram of a second apparatus according to one or more example embodiments of the present disclosure.

### DESCRIPTION OF EMBODIMENTS

In the following description, reference is made to the accompanying figures, which form part of the present disclosure, and which show, by way of illustration, specific aspects of embodiments of the present disclosure or specific aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

To assist in understanding the present disclosure, examples of wireless communication systems and devices are described below.

### Example Communication Systems and Devices

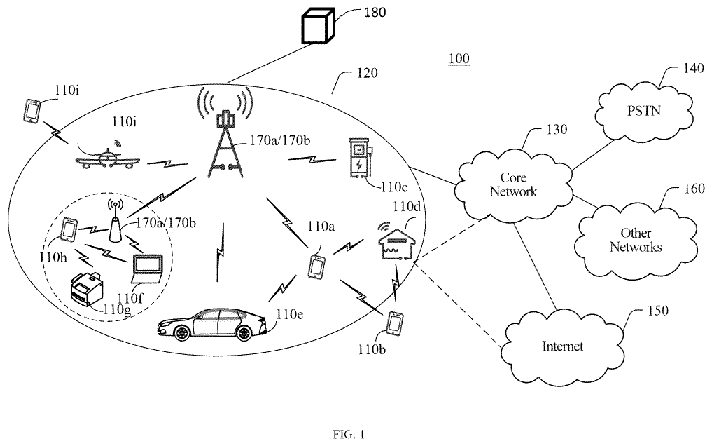

The present disclosure uses the interaction and processing procedures among at least one UE (i.e., the sensing device which is also called sensing node, which is marked as ED in FIG. 1), at least one BS (i.e., the central device) and at least one GPT devices in a wireless system as an illustrative example. The exchanged information and protocol flows can also be used between other network nodes described below, for example, between ED 110 and TRP 170, between ED 110 and core network, between ED 110 and ED 110, between TRP 170 and TRP 170, between TRP 170 and GPT device 180. The UE in the procedure described in the present disclosure may be replaced with a sensing node mentioned below. The BS in the procedure described in the present disclosure may be replaced with a sensing coordinator. Sensing coordinator are nodes in a network that can assist in the sensing operation. These nodes can be stand-alone nodes dedicated to just sensing operations or other nodes (for example TRP 170, ED 110, or core network node shown in FIG. 1) doing the sensing operations in parallel with communication transmissions.

Referring to FIG. 1, as an illustrative example without limitation, a simplified schematic illustration of a communication system according to one or more example embodiments of the present disclosure is provided. The communication system 100 (which may be the wireless system in FIG. 1) includes a radio access network 120. The radio access network 120 may be a next generation (e.g., sixth generation (6G) or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 includes a public switched telephone network (PSTN) 140, the internet 150, and other networks 160.

The uplink messages/data transmitted between the central device (e.g., the network node 170) and the sensing device (e.g., ED 110) could be carried in higher layer signaling, such as RRC signaling, or MAC layer signaling. Or, they could be carried in physical layer signaling, e.g., UCI. Or they could be carried in the combination of the higher layer signaling and the physical signaling. It could be noted that the message in the present disclosure could be replaced with information, which may be carried in one single message, or be carried in more than one separate message. The downlink messages/data transmitted between the central device and the ED 110 could be carried in higher layer signaling, such as RRC signaling, or MAC layer signaling. Or, they could be carried in physical layer signaling, e.g., UCI. Or they could be carried in the combination of the higher layer signaling and the physical signaling. It could be noted that the message in the present disclosure could be replaced with information, which may be carried in one single message, or be carried in more than one separate message.

In addition, the communication system 100 includes at least one GPT device 180. The GPT device 180 may be located within the one or more network node 170. The GPT device 180 may be an independent device connected to the network 170, such as an ED 110 which connected to the network node 170 via Uu interface. The GPT device 180 may be a device connected to the network node 170 via core network 130. When the GPT device 180 is an ED, the uplink messages/data transmitted between the central device (e.g., the network node 170) and the GPT device 180 could be carried in higher layer signaling, such as RRC signaling, or MAC layer signaling. Or, they could be carried in physical layer signaling, e.g., UCI. Or they could be carried in the combination of the higher layer signaling and the physical signaling. It could be noted that the message in the present disclosure could be replaced with information, which may be carried in one single message, or be carried in more than one separate message. The downlink messages/data transmitted between the central device and the GPT device 180 could be carried in higher layer signaling, such as RRC signaling, or MAC layer signaling. Or, they could be carried in physical layer signaling, e.g., UCI. Or they could be carried in the combination of the higher layer signaling and the physical signaling. It could be noted that the message in the present disclosure could be replaced with information, which may be carried in one single message, or be carried in more than one separate message.

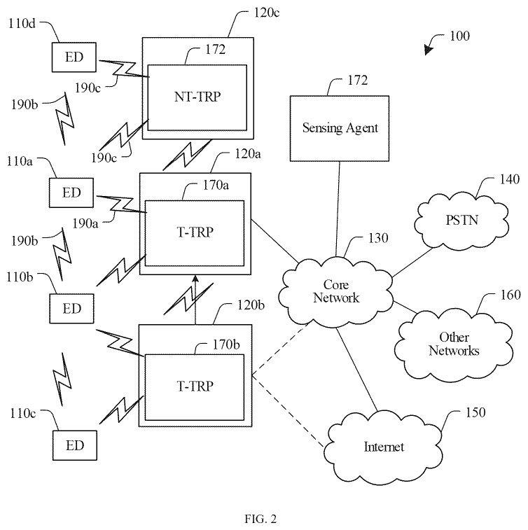

FIG. 2 is a schematic illustration of an example communication system according to one or more example embodiments of the present disclosure, where FIG. 2 illustrates an example communication system 100. In general, the communication system 100 enables multiple wireless or wired elements to communicate data and other content. The purpose of the communication system 100 may be to provide content, such as voice, data, video, signaling and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network including multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered as sub-systems of the communication system. In the example shown in FIG. 2, the communication system 100 includes electronic devices (ED) 110a, 110b, 110c, 110d (generically referred to as ED 110), radio access networks (RANs) 120a-120b, a non-terrestrial communication network 120c, a core network 130, a public switched telephone network (PSTN) 140, the Internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a-170b and NT-TRP 172, the Internet 150, the core network 130, the PSTN 140, the other networks 160, or any combination of the preceding. In some examples, ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), Direct Fourier Transform spread OFDMA (DFT-OFDMA) or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

### Basic Component Structure

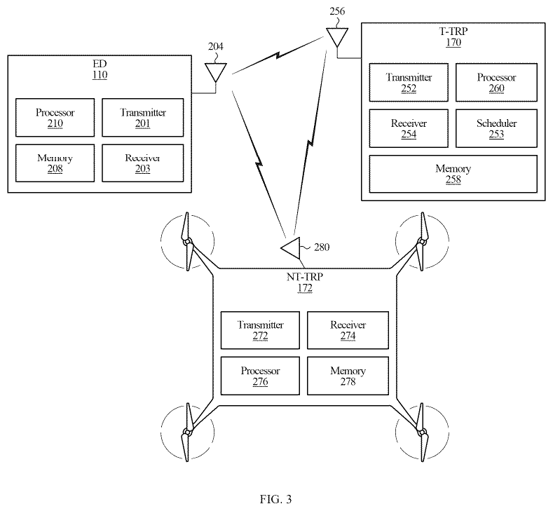

FIG. 3 is a schematic illustration of a basic component structure of a communication system according to one or more example embodiments of the present disclosure, where FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices such as a watch, head mounted equipment, a pair of glasses, an industrial device, or apparatus (e.g., communication module, modem, or chip) in the foregoing devices, among other possibilities. Future generation EDs 110 may be referred to using other terms. Each base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas 204 may alternatively be panels. The transmitter 201 and the receiver 203 may be integrated, e.g., as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to or receiving information from a user, such as through operation as a speaker, a microphone, a keypad, a keyboard, a display, or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., in the memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), a Central Processing Unit (CPU) or an application-specific integrated circuit (ASIC).

In some implementations, the ED 110 may be an apparatus (also called component) for example, communication module, modem, chip, or chipset, it includes at least one processor 210, and an interface or at least one pin. In this scenario, the transmitter 201 and receiver 203 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or another ED 110 may be referred as transmitting information to the interface or at least one pin, or as transmitting information to the NT-TRP 172 and/or the T-TRP 170 and/or another ED 110 via the interface or at least one pin, and receiving information from the NT-TRP 172 and/or the T-TRP 170 and/or another ED 110 may be referred as receiving information from the interface or at least one pin, or as receiving information from the NT-TRP 172 and/or the T-TRP 170 and/or another ED 110 via the interface or at least one pin. The information may include control signaling and/or data.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the foregoing devices or refer to apparatus (e.g., a communication module, a modem, or a chip) in the foregoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to the NT-TRP 172, and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming, and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g., a physical downlink control channel (PDCCH), and static or semi-static higher layer signaling may be included in a packet transmitted in a data channel, e.g., in a physical downlink shared channel (PDSCH).

The scheduler 253 may be coupled to the processor 260. The scheduler 253 may be included within or operated separately from the T-TRP 170. The scheduler 253 may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same or different one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU, a CPU, or an ASIC.

When the T-TRP 170 is an apparatus (also called as component), for example, communication module, modem, chip, or chipset in a device, it includes at least one processor, and an interface or at least one pin. In this scenario, the transmitter 252 and receiver 254 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or ED 110 may be referred as transmitting information to the interface or at least one pin, and receiving information from the NT-TRP 172 and/or the T-TRP 170 and/or ED 110 may be referred as receiving information from the interface or at least one pin. The information may include control signaling and/or data.

Although the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g., MIMO precoding), transmit beamforming, and generating symbols for transmission. Processing operations related to processing received transmissions in the uplink or over backhaul may include operations such as receive beamforming, demodulating received symbols and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU, a CPU, or an ASIC. In some embodiments, the NT-TRP 172 may actually be a plurality of NT-TRPs that are operating together to serve the ED 110, e.g., through coordinated multipoint transmissions.

When the NT-TRP 172 is an apparatus (e.g., communication module, modem, chip, or chipset) in a device, it includes at least one processor, and an interface or at least one pin. In this scenario, the transmitter 272 and receiver 257 may be replaced by the interface or at least one pin, wherein the interface or at least one pin is to connect the apparatus (e.g., chip) and other apparatus (e.g., chip, memory, or bus). Accordingly, the transmitting information to the T-TRP 170 and/or another NT-TRP 172 and/or ED 110 may be referred as transmitting information to the interface or at least one pin, and receiving information from the T-TRP 170 and/or another NT-TRP 172 and/or ED 110 may be referred as receiving information from the interface or at least one pin. The information may include control signaling and/or data.

Note that “TRP”, as used herein, may refer to a T-TRP or a NT-TRP. A T-TRP may alternatively be called a terrestrial network TRP (“TN TRP”) and a NT-TRP may alternatively be called a non-terrestrial network TRP (“NTN TRP”).

The T-TRP 170, the NT-TRP 172, and/or the ED 110 may include other components, but these have been omitted for the sake of clarity.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications, and are instead dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

Although not presented in FIG. 3, a GPT device 180 may be included, which has similar structure to ED 110, e.g., GPT device 180 includes at least one processor, a transmitter and a receiver.

### Basic Module Structure

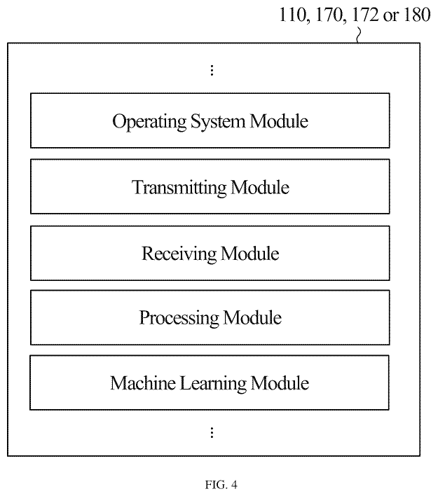

FIG. 4 is a block diagram of a device in a communication system according to one or more example embodiments of the present disclosure, where one or more steps of the embodiment methods provided herein may be performed by corresponding units or modules, according to FIG. 4. FIG. 4 illustrates units or modules in a device, such as in the ED 110, in the T-TRP 170, in the NT-TRP 172, or in the GPT device 180. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, a CPU, or an ASIC. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation. The transmitter mentioned with reference to FIG. 3 may be a detailed implementation for the transmitting module. The receiver mentioned with reference to FIG. 3 may be a detailed implementation for the receiving module. The processor mentioned with reference to FIG. 3 may be a detailed implementation for the processing module.

Additional details regarding the EDs 110, the T-TRP 170, the NT-TRP 172 and the GPT device 180 are known to those of skill in the art. As such, these details are omitted here.

The details of the present disclosure will be elaborated in the following description.

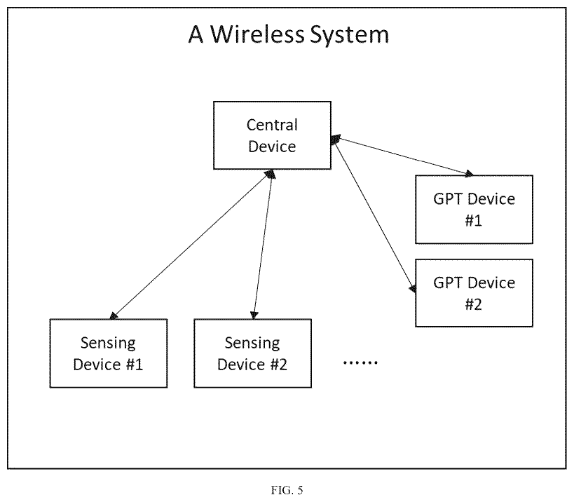

FIG. 5 is a schematic illustration of a semantic communication scenario according to one or more example embodiments of the present disclosure.

In present disclosure, the wireless system is also called communication system, or wireless communication system. Herein the wireless system includes a plurality of devices, for example, the plurality of devices include at least a central device, a plurality of distributed sensing devices and at least a GPT device (in FIG. 5).

The GPT device is responsible for encoding or decoding query messages and sensed data. In details, it generates a query message that contains one goal or goals in natural language for the central device; the central device semantizes the query message into a semantic vector, tokenizes the semantic vector into a goal semantic token (vector), and then broadcasts the goal token to the sensing devices. A sensing device, triggered by receiving the goal semantic token, measures its sensed data and converts the sensed data into a sensed semantic token. The sensing device compares and scores the relevance between the goal semantic token and sensed semantic token and transmit the sensed data in semantic vector only if the score of relevance is higher than a threshold. The central device fuses the sensed data in semantic vectors and outputs the fused one to the GPT device that will generate the next query message based on the fused input.

A central device may be a BS, e.g., gNB, or eNB etc., or the central device may be an access point (AP).

A sensing device is responsible for measuring and/or collecting local physical-world data. It may be sensing UE, sensing equipment, IoT equipment, UE, mobile phones, handset, or other equipment. The sensing device may be equipped with a sensing gadget or component to measure local physical-world data near it into a sensed data; the sensing encodes and transmits them to the central device.

A GPT device may generate a sequence of the query messages and receives a fused sensing message from the central device. In the present disclosure, the GPT device could be also called AI agent device, robot device, or smart controlling device.

In some implementations, a sensing device may be a UE, a mobile phone or a handset, wherein independence among any two sensing devices are assumed; thereby, a sensing device may be scheduled individually by the wireless system to which the sensing device is associated; and the sensed data that the sensing device measures may be application-level payload for the wireless system and protocol.

The above scheme of scheduling a sensing device is inefficient in terms of radio bandwidth and energy consumption. For instance, a sensing device blindly keeps transmitting its sensed data to the central device, regardless of whether the sensed data is required or not.

From a higher level perspective, it is better to wake a plurality of sensing devices to measure and transmit only when their sensed data would serve a goal or goals; for example, when a generative pre-trained transformer (GPT) device such as a driverless car, may request the information about the moving obstacles near itself, it is useless to keep transmitting irrelevant information to the driverless car, or to transmit all the moving obstacles nearby to the car when the car is parking on the roadside.

To avoid any missing probability of the information, resources in the wireless system in above implementations may be over-scheduled.

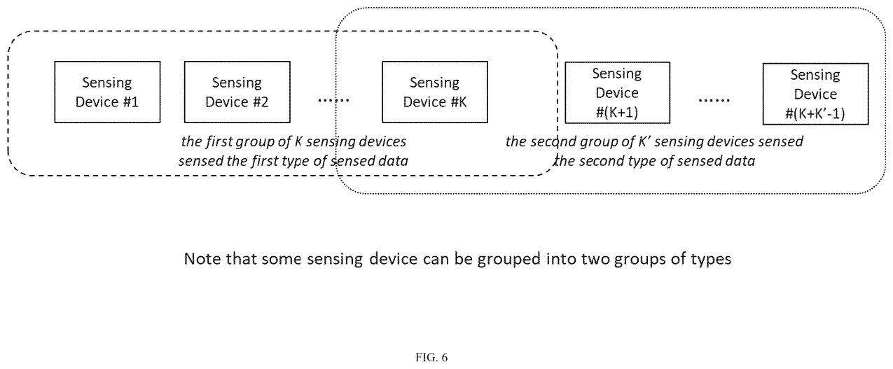

FIG. 6 is a schematic illustration of a plurality of the sensing devices in a semantic communication scenario according to one or more example embodiments of the present disclosure.

In details, a plurality of the sensing devices herein may be grouped or classified in terms of types of sensed data. The first group of the sensing devices may measure the first type of sensed data (e.g., red, green, blue (RGB) images or video), whereas the second group of sensing devices may measure the second type of sensed data (e.g., Radio RF point-cloud or Lidar Point cloud) as illustrated in FIG. 6.

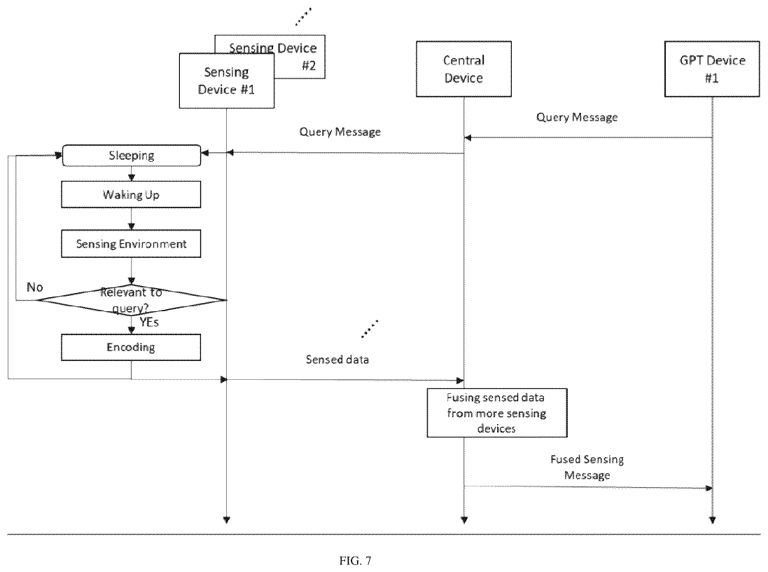

FIG. 7 is a schematic illustration of interaction among devices in a semantic communication scenario according to one or more example embodiments of the present disclosure.

The central device actively requests or triggers the sensing devices to transmit their most recent sensed data (in FIG. 7). Accordingly, the sensing devices will transmit their sensed data.

The central device may transmit the first query message or messages to one or some sensing devices in DL broadcast, multicast, or unicast channel or channel(s), which may be in physical broadcast channel, shared channel, or dedicated channel(s).

After a sensing device receives the first query message, the sensing device decides whether or not to transmit its sensed data. In details, the sensing device decodes the first query message, measures its data, and decides whether or not to transmit its sensed data, which is called as responding to the first query message. If the sensing device decides to respond to the first query message, the sensing device would encode/encapsulate the sensed data into a payload and then transmit it to the central device in UL channel or channel(s), which may be physical UL shared channel or dedicated UL channel.

After the central device of the wireless system receives all the payloads from the sensing devices that responded to the first query message, the central device may fuse all or some payloads into a fused payload. Optionally, the central device may input the fused payload into the GPT device that may process them and then generate the second query message.

The central device may transmit the second query message or messages to one or some sensing devices in DL broadcast, multicast, or unicast channel or channel(s).

The GPT device transmits the query messages to the central device to inform and configure the central device to schedule when, how, what, and which sensing devices to sense and transmit their sensed data to the central device. The GPT device may be implemented/located together with the central device for shorter latency, or the GPT device may be implemented in a remote data center, to which the central device may access via core network, or the GPT device may be on another connected device in the same wireless system of the central device. Please note that, in the present disclosure, the query message from the central device to the sensing device (downlink message) could be carried in higher layer signaling, such as radio resource control (RRC) signaling, or medium access control (MAC) layer signaling. Or, the query message could be carried in physical layer signaling, e.g., downlink control information (DCI). Or the query message is carried in the combination of the higher layer signaling and the physical signaling. It is similar for other downlink messages/data transmitted from the central device to the sensing device. Similarly, in the present disclosure, for uplink messages/data, they could be carried in higher layer signaling, such as RRC signaling, or MAC layer signaling. Or, they could be carried in physical layer signaling, e.g., uplink control information (UCI). Or they could be carried in the combination of the higher layer signaling and the physical signaling. It could be noted that the message in the present disclosure could be replaced with information, which may be carried in one single message, or be carried in more than one separate message.

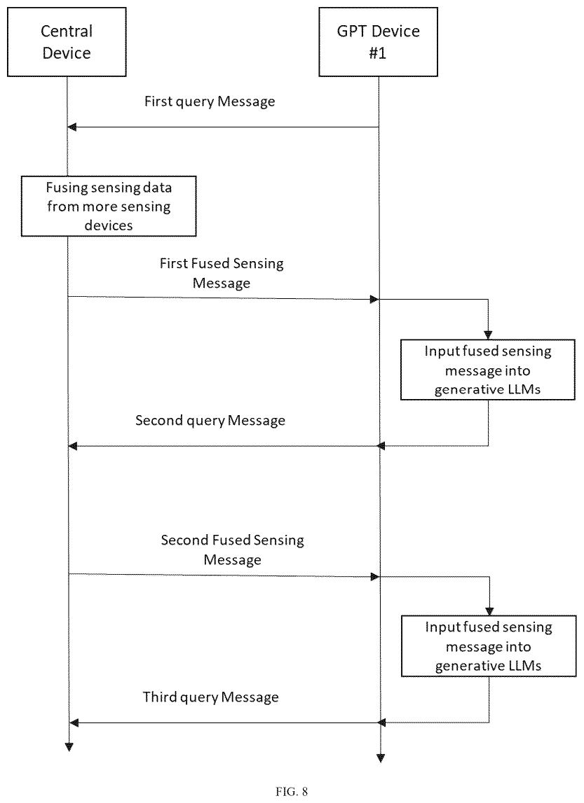

FIG. 8 is another schematic illustration of interaction among devices in a semantic communication scenario according to one or more example embodiments of the present disclosure.

The wireless system including a central device, sensing devices, and GPT device may form a series of interactions, in which the GPT device generates a sequence of the query messages for the sensing devices, the sensing devices collect and feedback the sensed data, and the central device fuses them and input them to the GPT device as illustrated in FIG. 8.

In some circumstances, some sensing devices may actively transmit their sensed data without receiving any query message from the central device. The sensing devices that transmit the sensed data may respond to some urgency queries such as fire alarming or car accident. In some sense, some query messages have been pre-defined and configured into the system by default.

FIG. 9 is a schematic flowchart of a method for semantic communications according to one or more example embodiments of the present disclosure. The method can be implemented by a first device. Optionally, the first device may be a sensing device or other device that has similar function (for example, the first device could be a chip), which is not limited herein. As shown in FIG. 9, the method may include the following steps.
S910, sending a first message, where the first message includes semantic capability information of a first device.

In an implementation, a first device such as a sensing device may send a first message to a second device such as a central device, where the first message may include semantic capability information of the first device. That is, the sensing device (UE) can send its capability to the central device (BS), indicating it's semantic/task capability.

The semantic capability information may indicate semantic related capability information or token related capability information. Specifically, the semantic capability information may indicate at least one of the following: whether a semantic capability is supported or not; a number of task types supported; a number of modality types supported; a query semantic level supported; a query semantic length supported; a query token level supported; a query token length supported; a sensing token length supported; a semantic model supported; a tokenization model supported; a tokenization function supported; or, a scoring function supported, where the scoring function is used to score a relevance of a piece of sensed data and/or a relevance of a sensing semantic. Because the semantic capability information indicates at least one of the above, the central device can know the semantic capability of the sensing device and send the second messages according to the semantic capability of the first device, and thus, the second messages from the central device to the sensing device can be sent in a targeted manner. Note that the at least two of above implementations for capability could be combined with each other.

In one possible implementation, the semantic/task capability indicates whether the sensing device support semantic/task capability or not. For example, there is a flag or one-bit indication. That is, the semantic capability information may include a flag or one-bit indication indicating whether the sensing device supports the semantic capability or not. Because the semantic capability information includes the flag or the one-bit indication, the central device can know whether the sensing device supports the semantic capability or not easily through the flag or indication, and will not send a message for semantic communication to the sensing device if the sensing device does not support the semantic capability, thereby saving communication resources.

In another possible implementation, the semantic/task capability indicates how many semantic/task types the sensing device can support. It can also indicate how many semantic/task modalities the sensing device can support. Optionally, the identifiers for the supported tasks/modalities can be included. For example, the semantic capability information may include at least one task identifier and/or at least one modality identifier, where each of the at least one task identifier indicates one task type supported by the sensing device, and each of the at least one modality identifier indicates one modality type supported by the sensing device. Thus the central device can know the task type and/or the modality type supported by the sensing device, and can send a message to the sensing device based on the task type and/or the modality type supported by the sensing device.

The identifiers can be obtained from broadcasted configuration (e.g., SSB, SIB), or can be pre-configured. In an example, the at least one task identifier and/or the at least one modality identifier may be obtained from broadcast configuration of a network device such as a central device, e.g., be carried in a synchronization signal and physical broadcast channel block (SSB) or a system information block (SIB), which can be flexible. In another example, the at least one task identifier or the at least one modality identifier may be pre-configured, e.g., be agreed by protocol or be pre-stored in the sensing device, which can save resources for transmission of the identifiers. Thus, the sensing device can inform the central device of the task type it supports and/or the modality type it supports through semantic capability information including the at least one task identifier and/or the at least one modality identifier.

In another possible implementation, the semantic/task capability can also indicate the supported semantic levels, and/or the supported query semantic lengths by the sensing device. In another possible implementation, the semantic/task capability can also indicate the supported query token levels, and/or the supported query token lengths, and/or the supported sensing token lengths by the sensing device. In another possible implementation, the semantic/task capability may also indicate the supported semantic/task models by the sensing device. In another possible implementation, the semantic/task capability may also indicate the supported tokenization model, or the functions/approaches for tokenization by the sensing device. In another possible implementation, the semantic/task capability may also indicate the supported scoring function by the sensing device.

Furthermore, there are several ways to transmit the semantic/task capability. It can be included in UE capability, or carried in other message. It may be reported based on carrier aggregation. It may be sent to the central device in a sequence. In an implementation, the sensing device may send the first message to the central device in a sequence. Accordingly, the central device can receive the first message in a sequence. When the first message is sent in a sequence, since the sequence is normally easy to generate and process, there may be less requirements on the processing capability or computing resources of the device sending the first message and the device receiving the first message. In another implementation, the sensing device may send the first message to the central device based on carrier aggregation. Accordingly, the central device can receive the first message based on carrier aggregation, thus the transmission efficiency can be improved.

The semantic/task capability can also be semantized (e.g., similar as the semantization process in later description), or tokenized (e.g., similar as the tokenization process in later description) first, and then sent to the central device. That is, the semantic capability information may be semantized or tokenized, thus the resources required for sending the first message including the semantic capability information can be saved.
S920, obtaining a second message sent based on the semantic capability information of the first device.

In a specific implementation, the sensing device may obtain a second message that is sent by the central device based on the semantic capability information of the sensing device. For example, the sensing device may obtain a piece of query-related information multicast or unicast by the central device based on the semantic capability information of the sensing device.

In an implementation, the piece of query-related information may include at least one query semantic and/or at least one query token. In an example, a task type and/or a modality type for each of the at least one query semantic or for each of the at least one query token is supported by the sensing device. In another example, a query semantic level for each of the at least one query semantic or a query token level for each of the at least one query token is supported by the sensing device. In another example, a query semantic length for each of the at least one query semantic or a query token length for each of the at least one query token is supported by the sensing device.

In other words, based on the received semantic/task capability from the sensing device, the central device can multicast or unicast the query semantics, or query tokens, to the sensing device based on its semantic/task capability. For example, the central device may only multicast/unicast a subset of the broadcasted query semantics/query tokens to this sensing device, due to its capacity (if only support partial semantic/task types, or partial semantic/task modalities). In another example, the central device may only multicast/unicast the query semantics/query tokens within a certain length to this sensing device (if only support some query semantic lengths, or some query token lengths).

Because the query-related information multicast or unicast based on the semantic capability information of the sensing device includes at least one query semantic and/or at least one query token whose task type and/or modality type, query semantic level or query semantic length is supported by the sensing device, which means, the obtained query semantic and/or query token is supported by the sensing device in terms of task/modality type, query semantic level, or query semantic length, then query semantics and/or query tokens beyond the semantic capability of the sensing device would not be obtained by the sensing device, thereby improving communication efficiency and saving communication resources.

After obtaining the second message sent by the central device based on the semantic capability information of the sensing device, the sensing device may further send a sensing result to the central device, where the sensing result includes at least one piece of sensed data and/or at least one sensing semantic. A sensing result including sensed data and/or sensing semantic may be sent after the second message is obtained, thereby providing a response to the query semantic and/or query token in the query-related information.

In a possible implementation, a score of relevance of each piece of the at least one piece of sensed data is higher than a first threshold; and/or, a score of relevance of each of the at least one sensing semantic is higher than a second threshold. Because a score of relevance of each piece of the at least one piece of sensed data and/or a score of relevance of each of the at least one sensing semantic is higher than a threshold, it ensures that the central device only needs to receive the relevant sensed data and/or sensing semantic, thereby saving communication resources.

In an implementation, the piece of query-related information includes at least one semantization model configuration, and the at least one semantization model configuration is supported by the sensing device; or, the piece of query-related information includes a semantization model configuration update, and the semantization model configuration update includes update information for the sensing device to update at least one outdated semantization model configuration to at least one updated semantization model configuration respectively, and the at least one updated semantization model configuration is supported by the sensing device.

Specifically, the central device can multicast or unicast the semantic/task model configurations to the sensing device based on its capabilities. The central device can also update the semantic/task model configurations to the sensing device based on its capabilities. For example, the central device may only multicast/unicast a subset of the broadcasted semantic/task models to this sensing device, due to its capacity (if only support partial semantic/task models).

Because the obtained query-related information multicast or unicast based on the semantic capability information of the sensing device includes at least one semantization model configuration that is supported by the sensing device, or includes a semantization model configuration update which includes update information for the sensing device to update at least one outdated semantization model configuration to at least one updated semantization model configuration that is supported by the sensing device, thus only the semantization model configuration or the updated semantization model configuration supported by the sensing device can be obtained, and those semantization model configurations that are not supported by the sensing device can be avoided, thereby saving communication resources.

In an implementation, the piece of query-related information includes at least one approach for tokenization, and the at least one approach for tokenization is supported by the sensing device. Each of the at least one approach for tokenization includes a tokenization model or a tokenization function. Specifically, the central device can multicast or unicast the tokenization models, or the functions/approaches for tokenization to the sensing device based on its capabilities. For example, the central device may only multicast/unicast a subset of the broadcasted tokenization models, or the functions/approaches for tokenization to this sensing device, due to its capacity (if only support partial tokenization models, or the functions/approaches for tokenization). Because the obtained query-related information multicast or unicast based on the semantic capability information of the sensing device includes at least one approach for tokenization that is supported by the sensing device, it ensures the availability of the approach for tokenization, e.g., the tokenization model or tokenization function, and avoids those approaches for tokenization that cannot be supported by the sensing device, thereby saving communication resources.

In an implementation, the piece of query-related information includes at least one scoring function, and the at least one scoring function is supported by the sensing device. For example, the central device can multicast or unicast the scoring functions to the sensing device based on its capabilities. For example, the central device may only multicast/unicast a subset of the broadcasted scoring functions to this sensing device, due to its capacity (if only support partial scoring functions). Because the obtained query-related information multicast or unicast based on the semantic capability information of the sensing device includes at least one scoring function that is supported by the sensing device, it ensures the availability of the scoring function, while avoiding those scoring functions not supported by the sensing device, thereby saving communication resources.

In a possible implementation, the sensing device may obtain the second message which is intended for a group of sensing devices that have same or qualified semantic capability, where the group of sensing devices includes the sensing device. Because the second message is intended for a group of sensing devices that have same or qualified semantic capability, relative to broadcasting the message to all the devices, communication is more effective, and power saving of devices can be achieved.

In a possible implementation, the second message includes paging information. The central device can send the paging information based on the semantic/task capabilities of sensing devices. For example, a semantic/task group can be defined, including the sensing devices with the same or similar semantic/task capabilities, or qualified semantic/task capabilities. Then a paging information can be sent to devices within a semantic/task group, instead of all the devices. Because the paging information is intended for a group of sensing devices that have same or qualified semantic capability, relative to broadcasting the paging information to all the devices, communication is more effective, and power saving of devices can be achieved. Other broadcast/multicast message can also use the similar approach, i.e., defining a semantic/task group and sending the message only to devices in this group.

With the method for semantic communications provided in the present disclosure, a first device such as a sensing device can send a first message that includes semantic capability information of the first device, so that a second device, such as a central device, can obtain the semantic capability information and send a second message to the first device based on the semantic capability information of the first device. Thus, messages beyond the semantic capability of the first device would not be obtained, thereby improving the efficiency of semantic communications and also saving communication resources.

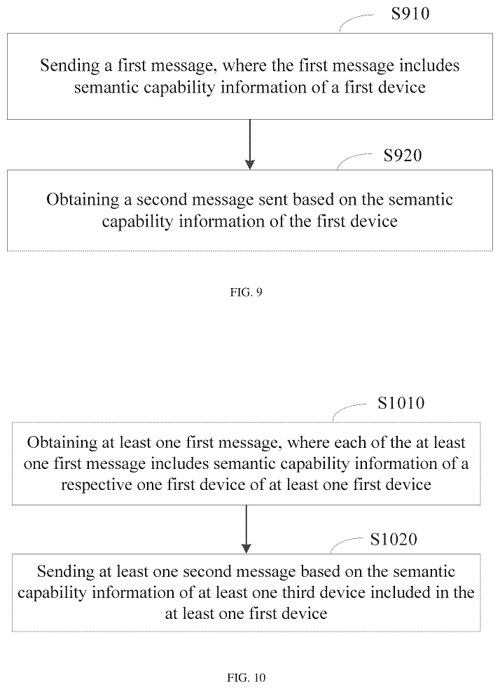

In the above, the method for semantic communications of the present disclosure is described from the perspective of the first apparatus (such as the sensing device) in combination with FIG. 9. In the following, a method for semantic communications of the present disclosure will be described from the perspective of the second apparatus (such as the central device) in combination with FIG. 10.

FIG. 10 is another schematic flowchart of a method for semantic communications according to one or more example embodiments of the present disclosure. The method can be implemented by a second device. Optionally, the second device may be a central device or other device that has similar function (for example, the second device could be a chip), which is not limited herein. As shown in FIG. 10, the method may include the following steps.
S1010, obtaining at least one first message, where each of the at least one first message includes semantic capability information of a respective one first device of at least one first device.

There may be at least one sensing device that sends at least one first message to a central device. Accordingly, the central device can receive the at least one first message from the at least one sensing device. Each of the at least one first message may include semantic capability information of a respective one sensing device of the at least one sensing device. That is, the central device (BS) can receive the capability of each of the at least one sensing device (UE) that indicates it's semantic/task capability.

The semantic capability information may indicate semantic related capability information or token related capability information. Specifically, the semantic capability information may indicate at least one of the following: whether a semantic capability is supported or not; a number of task types supported; a number of modality types supported; a query semantic level supported; a query semantic length supported; a query token level supported; a query token length supported; a sensing token length supported; a semantic model supported; a tokenization model supported; a tokenization function supported; or, a scoring function supported, where the scoring function is used to score a relevance of a piece of sensed data and/or a relevance of a sensing semantic. Because the semantic capability information indicates at least one of the above, the central device can know the semantic capability of the at least one sensing device, and the second messages according to the semantic capability of the third device can be sent, and thus, the second messages from the central device to the at least one sensing device can be sent in a targeted manner. Note that the at least two of above implementations for capability could be combined with each other.

In one possible implementation, the semantic/task capability indicates whether a sensing device supports semantic/task capability or not. For example, there is a flag or one-bit indication. That is, the semantic capability information may include a flag or one-bit indication indicating whether a sensing device from which a first message including the semantic capability information is obtained supports the semantic capability or not. Because the semantic capability information includes the flag or the one-bit indication, the central device can know whether the sensing device supports the semantic capability or not easily through the flag or indication, and will not send a message for semantic communication to the sensing device if the sensing device does not support the semantic capability, thereby saving communication resources.

In another possible implementation, the semantic/task capability indicates how many semantic/task types the sensing device can support. It can also indicate how many semantic/task modalities the sensing device can support. Optionally, the identifiers for the supported tasks/modalities can be included. For example, the semantic capability information may include at least one task identifier and/or at least one modality identifier, where each of the at least one task identifier indicates one task type supported by a sensing device from which a first message including the semantic capability information is obtained, and each of the at least one modality identifier indicates one modality type supported by a sensing device from which a first message including the semantic capability information is obtained. Thus the central device can know the task type and/or the modality type supported by a sensing device from which a first message including the semantic capability information is obtained, and can send a message to the sensing device based on the task type and/or the modality type supported by the sensing device.

The identifiers can be obtained from broadcasted configuration (e.g., SSB, SIB), or can be pre-configured. In an example, the at least one task identifier and/or the at least one modality identifier may be obtained by a sensing device from broadcast configuration of a network device such as a central device, e.g., be carried in a synchronization signal and physical broadcast channel block (SSB) or a system information block (SIB). For example, some identifiers (such as, task identifiers indicating tasks supported by a central device or a cell, modality identifiers indicating modalities supported by a central device or a cell) may be carried in broadcast configuration (e.g., SSB, SIB), and then a sensing device may obtain these identifiers, and determines therefrom at least one task identifier each indicating a task type supported by the sensing device or at least one modality identifier each indicating a modality type supported by the sensing device. In this way, flexible configuration of identifiers can be achieved. In another example, the at least one task identifier or the at least one modality identifier may be pre-configured, e.g., be agreed by protocol or be pre-stored in the sensing device, which can save resources for transmission of the identifiers. Thus, the central device can be informed of the task type and/or the modality type supported by the sensing device through semantic capability information including the at least one task identifier and/or the at least one modality identifier.

In another possible implementation, the semantic/task capability can also indicate the supported semantic levels, and/or the supported query semantic lengths by the sensing device. In another possible implementation, the semantic/task capability can also indicate the supported query token levels, and/or the supported query token lengths, and/or the supported sensing token lengths by the sensing device. In another possible implementation, the semantic/task capability may also indicate the supported semantic/task models by the sensing device. In another possible implementation, the semantic/task capability may also indicate the supported tokenization model, or the functions/approaches for tokenization by the sensing device. In another possible implementation, the semantic/task capability may also indicate the supported scoring function by the sensing device.

Furthermore, the semantic/task capability may be transmitted in several ways. It can be included in UE capability, or carried in other message. It may be reported based on carrier aggregation. It may be sent to the central device in a sequence. In an implementation, at least one sensing device may send at least one first message to the central device in a sequence. Accordingly, the central device can receive the at least one first message in a sequence. Since the sequence is normally easy to process, there may be less requirements on the processing capability or computing resources of the device sending the first message and the device receiving the first message. In another implementation, at least one sensing device may send at least one first message to the central device based on carrier aggregation. Accordingly, the central device can receive the at least one first message based on carrier aggregation, thus the transmission efficiency can be improved.

The received semantic/task capability by the central device can also be semantized (e.g., similar as the semantization process in later description), or tokenized (e.g., similar as the tokenization process in later description), that is, the semantic capability information included in a received first message may be semantized or tokenized, thus the resources required for receiving the first message including the semantic capability information can be saved.
S1020, sending at least one second message based on the semantic capability information of at least one third device included in the at least one first device.

Since not every sensing device supports semantic capability, and each sensing device may support different semantic capability, the central device may multicast or unicast at least one piece of query-related information to partial sensing devices, based on the semantic capability information of the partial sensing devices. For example, the partial sensing devices may be the at least one third device included in the at least one first device.

In an implementation, each piece of query-related information may include at least one query semantic and/or at least one query token. In an example, a task type and/or a modality type for each of the at least one query semantic or for each of the at least one query token is supported by a sensing device to which the each piece of query-related information is multicast or unicast. In another example, a query semantic level for each of the at least one query semantic or a query token level for each of the at least one query token is supported by a sensing device to which the each piece of query-related information is multicast or unicast. In another example, a query semantic length for each of the at least one query semantic or a query token length for each of the at least one query token is supported by a sensing device to which the each piece of query-related information is multicast or unicast.

In other words, based on the received semantic/task capability from a sensing device, the central device can multicast or unicast the query semantics, or query tokens, to the sensing device based on its semantic/task capability. For example, the central device may only multicast/unicast a subset of the broadcasted query semantics/query tokens to this sensing device, due to its capacity (if only support partial semantic/task types, or partial semantic/task modalities). In another example, the central device may only multicast/unicast the query semantics/query tokens within a certain length to this sensing device (if only support some query semantic lengths, or some query token lengths).

Because the query-related information multicast or unicast based on the semantic capability information of the third device includes at least one query semantic and/or at least one query token whose task type and/or modality type, query semantic level or query semantic length is supported by the third device, which means, the multicast or unicast query semantic and/or query token is supported by the third device in terms of task/modality type, query semantic level, or query semantic length, then query semantics and/or query tokens beyond the semantic capability of the third device would not be sent to the third device, thereby improving communication efficiency and saving communication resources.

After sending the at least one second message to the at least one third device included in the at least one first device based on the semantic capability information of the at least one third device, the central device may further receive a sensing result, where the sensing result includes at least one piece of sensed data and/or at least one sensing semantic. A sensing result including sensed data and/or sensing semantic may be obtained after the second message is sent, and the sensing result provides a response to the query semantic and/or query token in the query-related information.

In a possible implementation, a score of relevance of each piece of the at least one piece of sensed data is higher than a first threshold; and/or, a score of relevance of each of the at least one sensing semantic is higher than a second threshold. Because a score of relevance of each piece of the at least one piece of sensed data and/or a score of relevance of each of the at least one sensing semantic is higher than a threshold, it ensures that only the relevant sensed data and/or sensing semantic is received, thereby saving communication resources.

In a possible implementation, each piece of query-related information of the at least one piece of query-related information includes at least one semantization model configuration, and the at least one semantization model configuration is supported by a third device to which the each piece of query-related information is multicast or unicast; or, each piece of query-related information of the at least one piece of query-related information includes a semantization model configuration update, and the semantization model configuration update includes update information for a third device to which the each piece of query-related information is multicast or unicast to update at least one outdated semantization model configuration to at least one updated semantization model configuration respectively, and the at least one updated semantization model configuration is supported by the third device to which the each piece of query-related information is multicast or unicast.

Specifically, the central device can multicast or unicast the semantic/task model configurations to a sensing device based on its capabilities. The central device can also update the semantic/task model configurations to the sensing device based on its capabilities. For example, the central device may only multicast/unicast a subset of the broadcasted semantic/task models to this sensing device, due to its capacity (if only support partial semantic/task models).

Because the query-related information multicast or unicast based on the semantic capability information of the third device includes at least one semantization model configuration that is supported by the third device, or includes a semantization model configuration update which includes update information for the third device to update at least one outdated semantization model configuration to at least one updated semantization model configuration that is supported by the third device, thus only the semantization model configuration or the updated semantization model configuration supported by the third device can be obtained, and those semantization model configurations that are not supported by the third device can be avoided, thereby saving communication resources.

In an implementation, each piece of query-related information of the at least one piece of query-related information includes at least one approach for tokenization, and the at least one approach for tokenization is supported by a third device to which the each piece of query-related information is multicast or unicast. Each of the at least one approach for tokenization includes a tokenization model or a tokenization function. Specifically, the central device can multicast or unicast the tokenization models, or the functions/approaches for tokenization to a sensing device based on its capabilities. For example, the central device may only multicast/unicast a subset of the broadcasted tokenization models, or the functions/approaches for tokenization to this sensing device, due to its capacity (if only support partial tokenization models, or the functions/approaches for tokenization). Because the query-related information multicast or unicast based on the semantic capability information of the third device includes at least one approach for tokenization that is supported by the third device, it ensures the availability of the approach for tokenization, e.g., the tokenization model or tokenization function, and avoids those approaches for tokenization that cannot be supported by the third device, thereby saving communication resources.

In an implementation, each piece of query-related information of the at least one piece of query-related information includes at least one scoring function, and the at least one scoring function is supported by a third device to which the each piece of query-related information is multicast or unicast. For example, the central device can multicast or unicast the scoring functions to the sensing device based on its capabilities. For example, the central device may only multicast/unicast a subset of the broadcasted scoring functions to this sensing device, due to its capacity (if only support partial scoring functions). Because the query-related information multicast or unicast based on the semantic capability information of the third device includes at least one scoring function that is supported by the third device, it ensures the availability of the scoring function, while avoiding those scoring functions not supported by the third device, thereby saving communication resources.

In a possible implementation, the central device may send the at least one second message which is intended for a group of sensing devices that have same or qualified semantic capability, where the group of sensing devices includes the at least one third device. Because the second message is intended for a group of sensing devices that have same or qualified semantic capability, relative to broadcasting the message to all the devices, communication is more effective, and power saving of devices can be achieved.

In a possible implementation, the at least one second message includes paging information. The central device can send the paging information based on the semantic/task capabilities of sensing devices. For example, a semantic/task group can be defined, including the sensing devices with the same or similar semantic/task capabilities, or qualified semantic/task capabilities. Then a paging information can be sent to devices within a semantic/task group, instead of all the devices. Because the paging information is intended for a group of sensing devices that have same or qualified semantic capability, relative to broadcasting the paging information to all the devices, communication is more effective, and power saving of devices can be achieved.

With the method for semantic communications provided in the present disclosure, a second device such as a central device may obtain at least one first message from at least one first device such as at least one sensing device, where each of the at least one first message includes semantic capability information of a respective one first device of the at least one first device, and may send at least one second message based on the semantic capability information of at least one third device included in the at least one first device. Because the second message is sent based on the semantic capability information of at least one third device included in the at least one first device, the second message will only be sent to those devices supporting corresponding semantic capability, improving the efficiency of semantic communications and also saving communication resources.

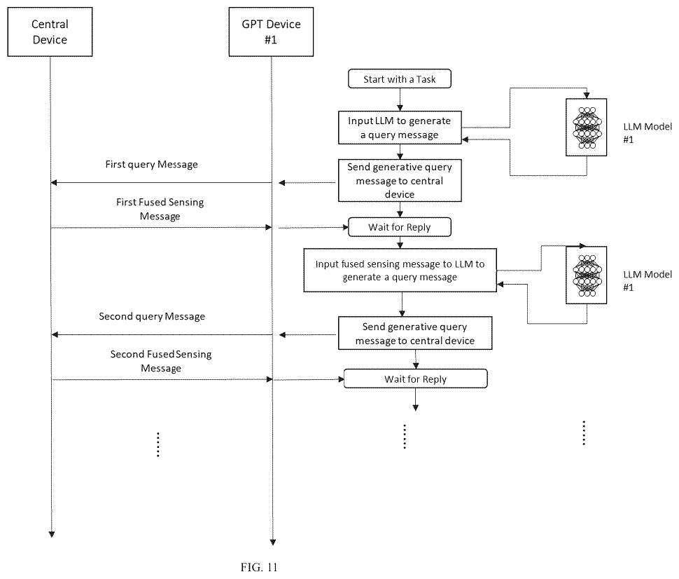

FIG. 11 is a schematic illustration of realizing a chain of thoughts according to one or more example embodiments of the present disclosure, which shows how a chain of thoughts is realized by generative AI model and is embodied by a sequence of query messages in a possible implementation.

A GPT device may generate a sequence of the query messages based on the previous sensing messages, wherein the previous sensing messages are received and/or fused by the central device. The GPT device may infer one or several generative AI models. The generative AI model or model inferences deep neural network or networks (DNN) to output a query message or messages. The GPT device generates a sequence of the query messages, called as “a chain of the thoughts” by interacting with a sequence of the fused sensing messages into which the central device fuses the sensed data transmitted by the responsive sensing devices; as illustrated in FIG. 11.

A query message that the GPT device generate may convey semantic goals, tasks, or objectives. For example, a query message of “localize an incoming pedestrians” explicitly establishes a semantic goal for the sensing devices to focus on its nearby pedestrian and to prevent the sensing devices from being distracted. Since a query message conveys a semantic goal or goals, the query message that the central device transmits to the sensing devices may trigger a goal-oriented sensing task at each responsive sensing device that receives and responds to the very query message. Please note that a message may convey several goals. For example, a message of “find a moving pedestrian with white coat” conveys two semantic goals or tasks: a moving pedestrian and a pedestrian with white coat.

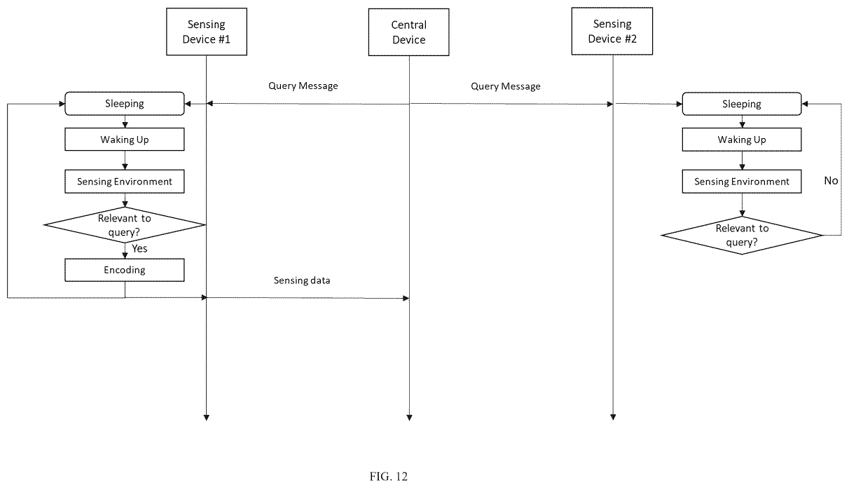

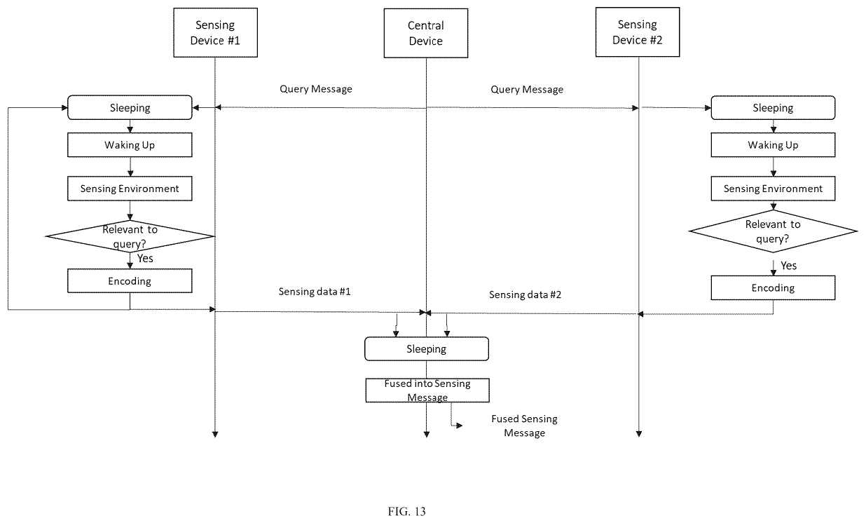

FIG. 12 is another schematic illustration of interaction among devices in a semantic communication scenario according to one or more embodiments of the present disclosure. In a possible implementation, as shown in FIG. 12, the central device may broadcast a sequence of the query messages, because it may be too costly or even forbidden to schedule sensing device individually in a wireless system including such a high density of sensing devices. Therefore, once a sensing device receives a query message, the sensing device may become waken but with little idea whether or not its sensed data is sufficiently relevant to the goal conveyed by the query message. Thereby the sensing device may enable its sensing gadget to sense its nearby environment into a sensed data and compare the sensed data with the query message. If the sensing device tells that the sensed data is sufficiently relevant with the query message, the sensing device encodes and transmits the sensed data to the central device (Sensing Device #1 in FIG. 12). Otherwise, the sensing device may not respond to the query message at all (Sensing Device #2 in FIG. 12). In this sense, the wireless system doesn't schedule individual sensing device but schedule a common task across a collectivity of sensing devices. FIG. 13 is another schematic illustration of interaction among devices in a semantic communication scenario according to one or more embodiments of the present disclosure. In a possible implementation, as shown in FIG. 13, the central device may receive a plurality of sensed data from some or all the sensing devices that respond to the query message at the end of a pre-defined responding timing interval. The central device may fuse all the sensed data into one sensing message and input the sensing message to the GPT device that would generate the next query message based on the sensing message, as shown in 13. Because only those sensing devices that respond to the query message would transmit the sensed data, lots of radio resource would be saved in comparison with one-to-one scheduling algorithm.

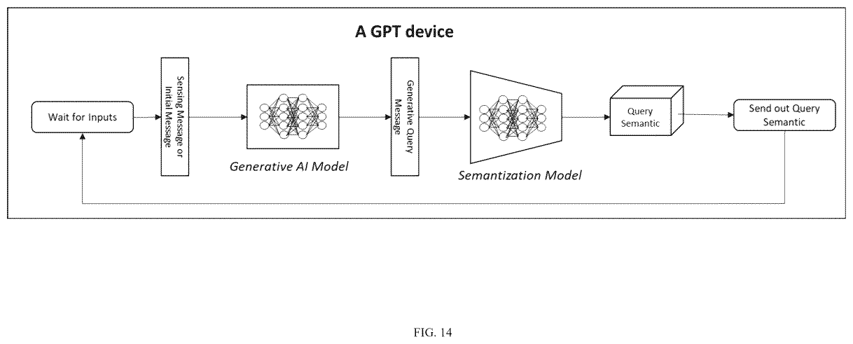

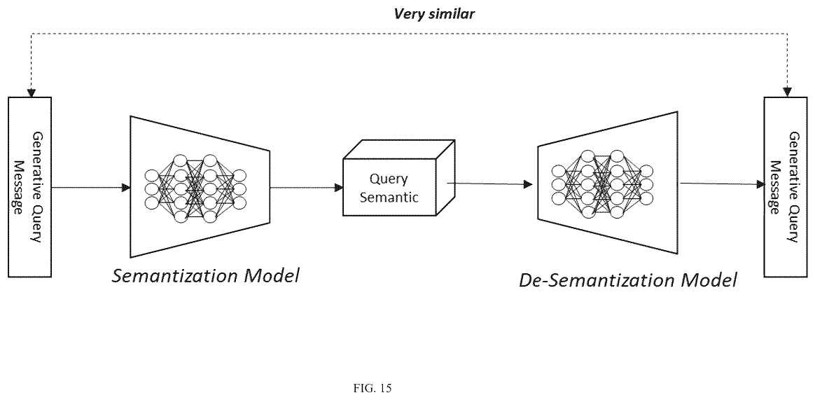

FIG. 14 is a schematic illustration of generating a query message, which shows how the GPT device uses generative AI model to generate the query message and then use semantization model to translate the query message into a query semantic in a possible implementation. FIG. 15 is a schematic illustration of reversing a semantic, which shows how the semantic is reversible in a possible implementation, meaning that if someone had a de-semantization model, he could recover a query message from a query semantic.

A sequence of the query messages that the GPT device generates and the central device broadcasts is in a natural language, that is, human-readable. The GPT device may employ a LLM (large-language-model) to inference over a fused sensing message (in a natural language too) input to generate a new query message. The LLM model may be a “standard” foundation model like a transformer, or a “custom” model that is built for a narrower vocabulary and specific scenarios. For example, a customized LLM for dealing with industry 4.0 or a customized LLM for dealing with wireless communication signaling and protocols. The GPT device may change, update, downsize, upsize, replace its LLM or LLMs anytime as it wishes. Please note that broadcast, multicast or unicast is allowed.

A query message that the GPT device generates is in a natural language. Because of randomness in generating, two different query messages may convey very similar semantic goal or goals. For example, “find a pedestrian” and “localize a walking man” may have the same semantic goal. Therefore, the GPT device may semantize a query message into a query semantic, which is called as “embedding”, “semantization”, “encoding”, “natural-language to machine translation” and so on. The GPT device may translate a query message into a query semantic that may include a vector, a matrix, or a tensor of scalars. The translation may be realized by deep-neural network or other classic functions. A query semantic may preserve all the key semantic goals conveyed by the query message such that the query semantic can be well translated (de-semantized) back to a query message. Optionally, the GPT device may transmit a query semantic instead of a query message to the central device, as illustrated in FIG. 14. Please note that if all the LLMs outputs to a common natural language (e.g., English), these LLMs are said to be aligned by the natural language; then whatever LLMs are used, everyone can be smoothly hooked into the GPT device and work well within the wireless system.

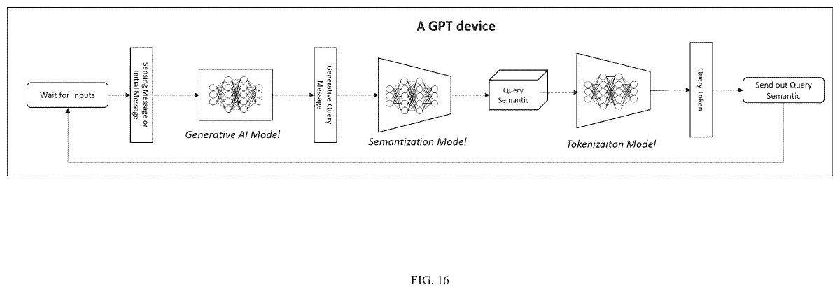

FIG. 16 is a schematic illustration of tokenizing a query semantic into a query token, which shows how a GPT device tokenizes a query semantic into a query token in a possible implementation.

In one implementation, the central device may further tokenize a query semantic into a query token. A query token is a fixed-length semantic but including a vector of scalars, simpler for transmission and comparison purposes. The wireless system may pre-specify a plurality of lengths for query tokens. Thus, the central device may choose a right token length when tokenizing a query semantic according to the size range of the query semantic. The tokenization can be such a harsh function to prevent a sensing device from recovering a complete query message from a query token. The tokenization may come up with certain privacy protection for query messages. The tokenization may be realized by deep-neural network or other classic functions; as shown in FIG. 16.

Optionally, the central device receives a query semantic from the GPT device, and then the central device converts the query semantic into a query token with a fixed length; the central device may broadcast the query token with the length to all the sensing devices; the central device may keep the query semantic in its memory or storage to check the feedback sensed data.

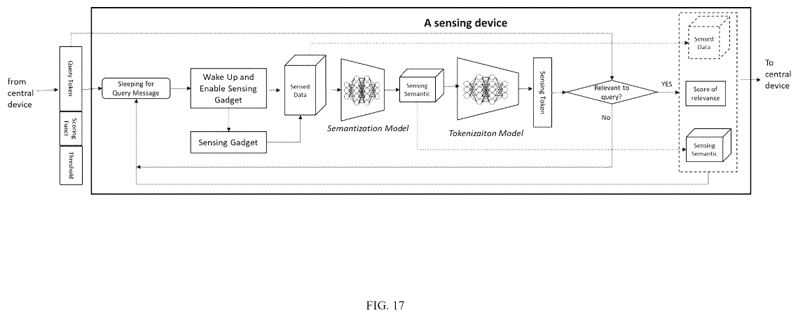

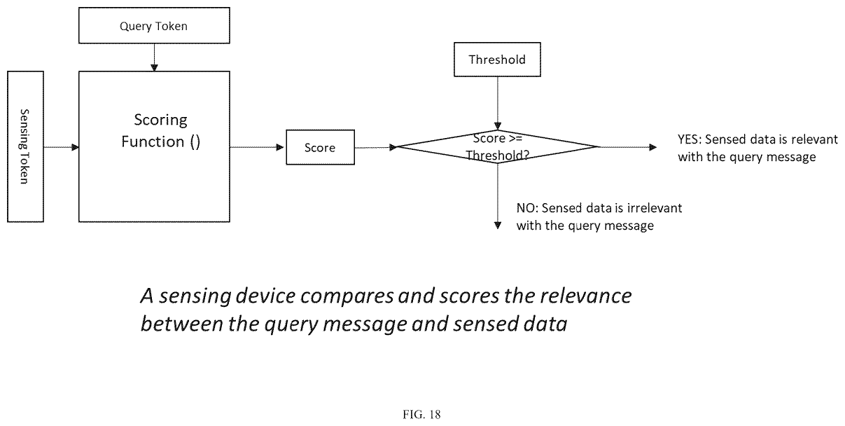

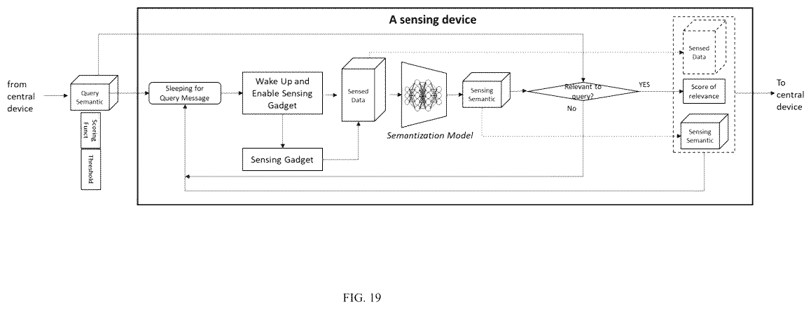

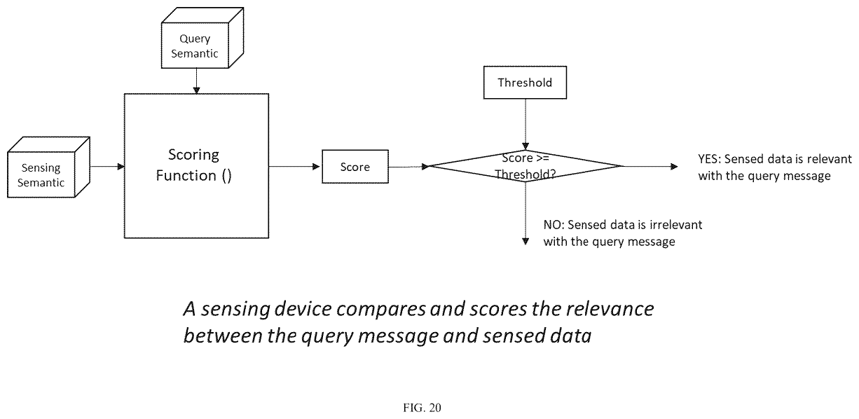

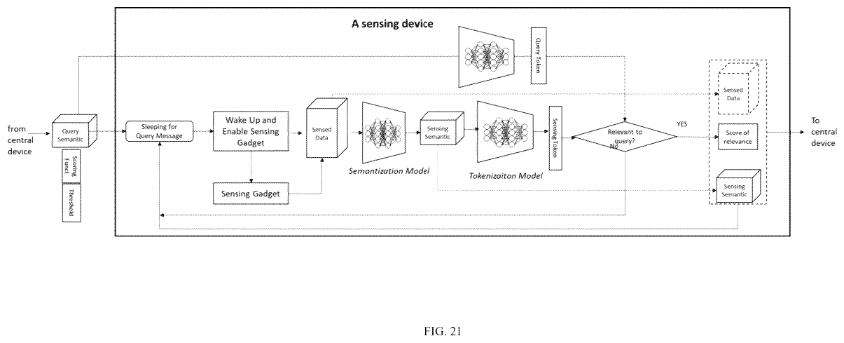

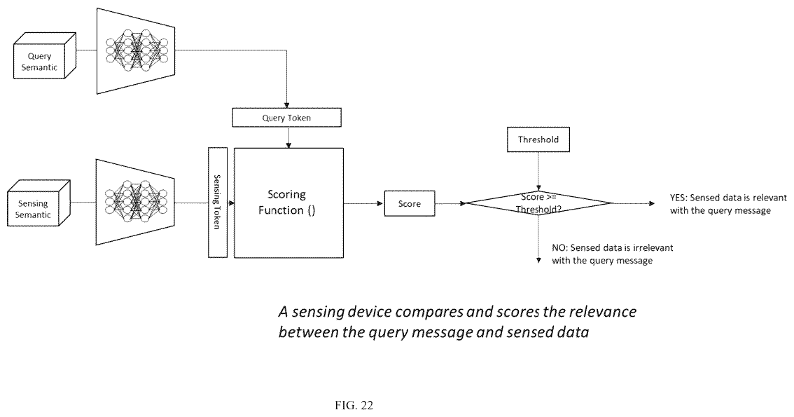

FIG. 17 is a schematic illustration of responding to a query token, which shows how a sensing device responds to a query token in a possible implementation. FIG. 18 is a schematic illustration of scoring the relevance with tokens, which shows how a sensing device scores the relevance with tokens in a possible implementation. FIG. 19 is another schematic illustration of responding to a query token, which shows how a sensing device responds to a query token in a possible implementation. FIG. 20 is a schematic illustration of scoring a relevance with semantic, which shows how a sensing device scores the relevance with semantic in a possible implementation. FIG. 21 is another schematic illustration of responding to a query token, which shows how a sensing device responds to a query token in a possible implementation. FIG. 22 is a schematic illustration of scoring the relevance with tokens converted from semantics, which shows how a sensing device scores the relevance with tokens converted from semantics in a possible implementation.

A sensing device may compare its sensed data with the query message; after the sensing device receives a query token (with its length or indicator of its length), the sensing device is waked up to enable its sensing gadget to measure its nearby physical-word environment into a sensed data; the sensing device may be equipped with one LLM or LLMs as semantization model and input the sensed data into the semantization model to output a sensing semantic; optionally, the sensing device may choose a right length and format of the sensing semantic; and the sensing device may continue to tokenize the sensing semantic into a sensing token with the same length as the query token that the sensing device has received; the sensing device compares or scores the relevance between the query message and sensed data, which is based on what the sensing device has received:
Alternative #1 (FIG. 17 and FIG. 18): the sensing device receives a query token and scoring function; it compares and scores the relevance between the query token and the sensing token; if the score of relevance was greater than or equal to a pre-defined threshold, the sensing device would tell that the sensed data is sufficiently relevant with the query message from the central device.
Alternative #2 (FIG. 19 and FIG. 20): the sensing device receives a query semantic and scoring function; it compares and scores the relevance between the query semantic with the sensing semantic, if both semantics are in a similar size and format; if the score of relevance was greater than or equal to a pre-defined threshold, the sensing device would tell that the sensed data is sufficiently relevant with the query message from the central device.
Alternative #3 (FIG. 21 and FIG. 22): the sensing device receives a query semantic and scoring function; it firstly converts the query semantic into a query token by the local tokenization model; and it compares and scores the relevance between the query token and sensing token; if the score of relevance was greater than or equal to a pre-defined threshold, the sensing device would tell that the sensed data is sufficiently relevant with the query message from the central device.

If the score of relevance is greater than or equal to a pre-defined threshold, the sensing device may transmit information including the sensed data and optionally the score of relevance to the central device. The following are some alternatives of the contents in the transmitted information:
Alternative #1: raw sensed data
Alternative #2: sensing semantic
Alternative #3: half raw sensed data (e.g., exact value or number)+sensing semantic
Alternative #4: raw sensed data+score of relevance
Alternative #5: sensing semantic+score of relevance
Alternative #6: half raw sensed data (e.g., exact value or number)+sensing semantic+score of relevance.

A sensing device may be equipped with one or several semantization models to generate sensing semantic from sensed (raw) data, may be equipped with tokenization model to generate sensing token from sensing semantic, and may be configured to have a scoring function; unlike the GPT device, the LLMs, tokenization model, and scoring functions that a sensing device may use are configured by the central device; the central device may configure and inform the sensing devices of a common LLMs and/or tokenization model and scoring function at all the beginning or on the run.

A plurality of sensing devices, either in one type or in multiple types, may serve one or several tasks simultaneously; in an efficient way, a sensing device may be triggered once to serve as many tasks as possible.

A wireless system may include two GPT devices, or one GPT device that can conduct two separated tasks; in the following disclosure, two GPT devices is mentioned as an example. And the two GPT devices may be easily extended to one GPT device with two separated tasks.

Although the two GPT devices have their own separate and independent tasks, the two GPT devices may trigger the same sensing devices simultaneously; for example, a driverless car GPT device and a traffic-light GPT device may trigger the same roadside camera sensing devices; nevertheless, although the same sensing devices may be triggered by two GPT devices at the same time interval, the query message from the first GPT device may be different from the query message from the second GPT device; for example, the driverless car GPT device may broadcast a query message about “moving obstacles” and the traffic-light GPT device may broadcast a query message about “density of vehicles”, both of which may be somehow relevant but not similar.

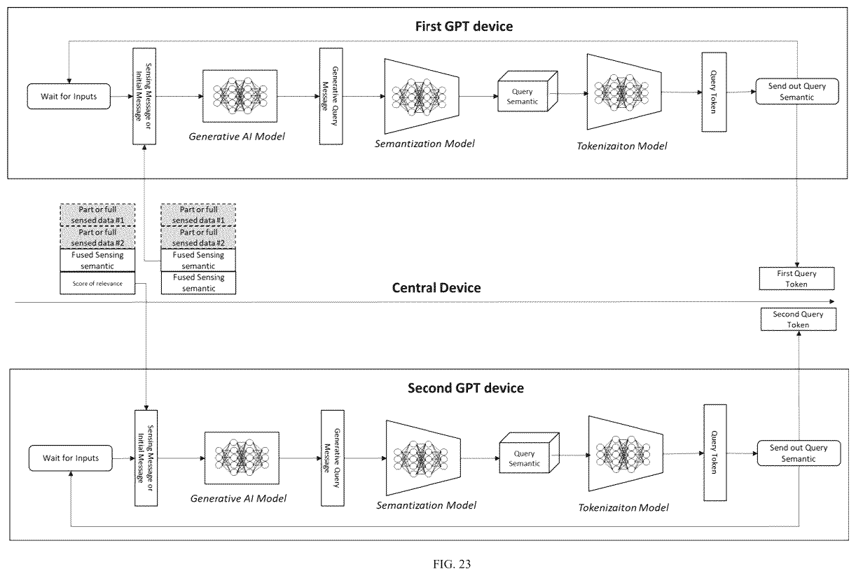

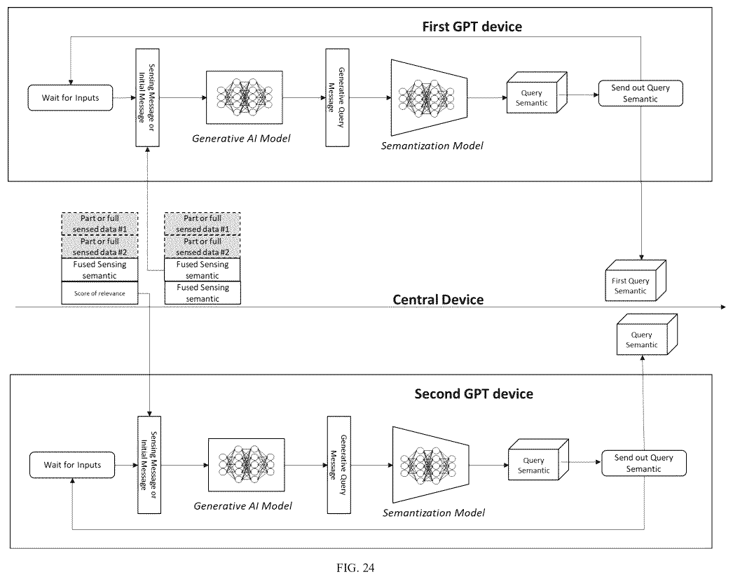

FIG. 23 is a schematic illustration of generating query tokens, which shows how GPT devices generate the query tokens in a possible implementation. FIG. 24 is a schematic illustration of generating query semantics, which shows how GPT devices generate the query semantics in a possible implementation.

The first GPT device generates the first query semantic to the central device and the second GPT device generates the second query semantic to the central device. There are two options shown as follows:
Alternative #1: as shown in FIG. 23, the central device may tokenize the first query message into the first query token and tokenize the second query message into the second query token; the central device may use the first tokenization model to tokenize the first query message and the second tokenization model to tokenize the second query message, or the central device may use a common tokenization model to tokenize the first query message and the second query message; then the central device may broadcast the first query token, the length of the first token, the first scoring function related to the first token, and the first threshold related to the first scoring function, and the second query token the length of the second token, the second scoring function related to the second token, and the second threshold related to the second scoring function in a multiplex way in DL channel(s).
Alternative #2: as shown in FIG. 24, the central device may not perform the tokenization, and the central device may broadcast the first query semantic, the length and format of the first semantic, the first scoring function related to the first semantic, and the first threshold related to the first scoring function, and the second query message the length of the second message, the second scoring function related to the second message, and the second threshold related to the second scoring function in a multiplex way in DL channel(s).

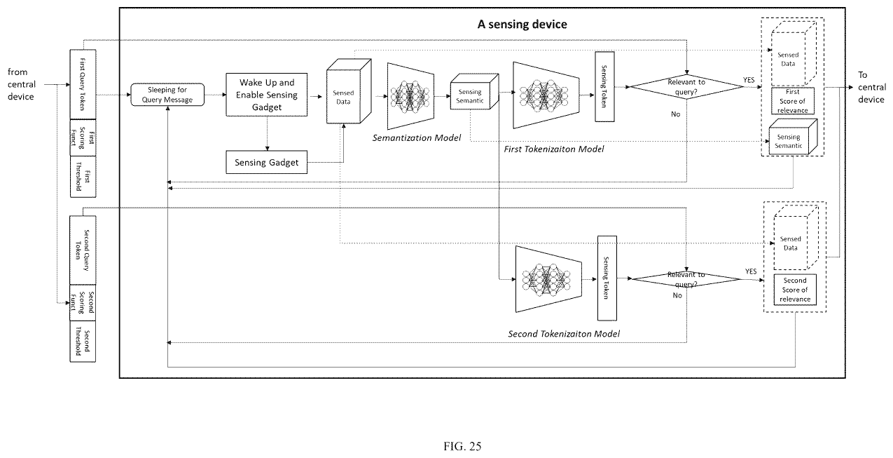

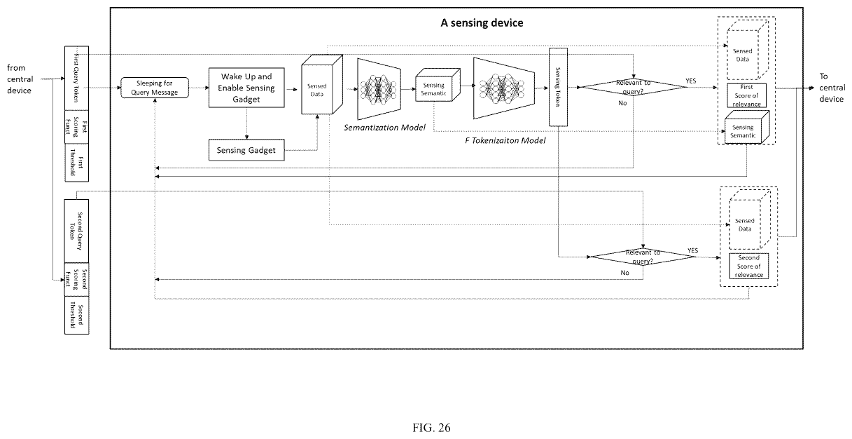

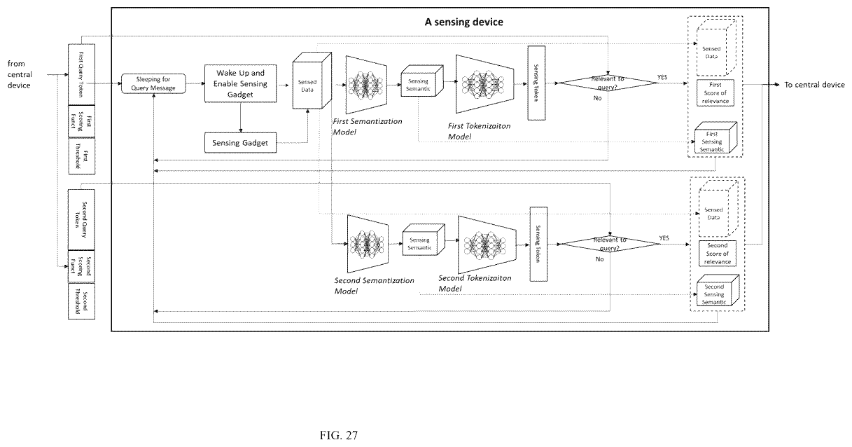

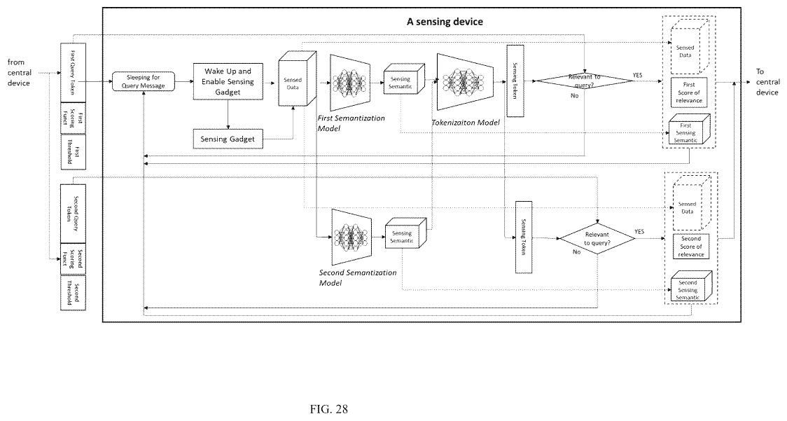

FIG. 25 is a schematic illustration of responding to two queries with a common semantization model and two tokenization models, which shows how a sensing device responds to two queries with a common semantization model and two tokenization models in a possible implementation. FIG. 26 is a schematic illustration of responding to two queries with a common semantization model and a common tokenization model, which shows how a sensing device responds to two queries with a common semantization model and a common tokenization model in a possible implementation. FIG. 27 is another schematic illustration of responding to two queries with two semantization models and two tokenization models, which shows how a sensing device responds to two queries with two semantization models and two tokenization models in a possible implementation. FIG. 28 is another schematic illustration of responding to two queries with two semantization models and a common tokenization model, which shows how a sensing device responds to two queries with two semantization models and a common tokenization model in a possible implementation.

A sensing device may receive both the first query token and the second query token and wakes to enable its sensing gadget to sense the physical-world around itself into a sensed data. There are two options shown as follows:
Alternative #1: the sensing device may convert the sensed data into one common sensing semantic by one LLM or LLMs; and then the sensing device may tokenize the sensing semantic into the first sensing token in terms of the length of the first query token and tokenize the sensing semantic into the second sensing token in terms of the length of the second query token, in which the sensing device may use the first tokenization model to tokenize the sensing semantic into the first sensing token and the second tokenization model to tokenize the sensing semantic into the second sensing token (FIG. 25), or may use a common tokenization model to tokenize the sensing semantic into both the first sensing token and the second sensing token (FIG. 26); the sensing device may score the relevance between the first query token and the first sensing token and the relevance between the second query token and the second sensing token; the sensing device may tell whether or not the sensed data provides an enough relevance to the first query token if the first score of the relevance is greater than or equal to the first threshold, and the sensing device may tell whether or not the sensed data provides an enough relevance to the second query token if the second score of the relevance is greater than or equal to the second threshold; the sensing device may transmit at least one of the sensed data, sensing semantic or the first score of relevance if deciding the first score of relevance is high enough; the sensing device may transmit at least one of the sensed data, sensing semantic or the second score of relevance if deciding the second score of relevance is high enough.
Alternative #2: as shown in FIG. 26, the sensing device may convert the sensed data into the first sensing semantic by one LLM or LLMs and convert the same sensed data into the second sensing semantic by one LLM or LLMs; and then the sensing device may tokenize the first sensing semantic into the first sensing token in terms of the length of the first query token and tokenize the second sensing semantic into the second sensing token in terms of the length of the second query token, in which the sensing device may use the first tokenization model to tokenize the first sensing semantic into the first sensing token and the second tokenization model to tokenize the second sensing semantic into the second sensing token (as shown in FIG. 27), or may use a common tokenization model to tokenize the sensing semantic into both the first sensing token and the second sensing token (as shown in FIG. 28); the sensing device may score the relevance between the first query token and the first sensing token and the relevance between the second query token and the second sensing token; the sensing device may tell whether or not the sensed data provides an enough relevance to the first query token if the first score of the relevance is greater than or equal to the first threshold, and the sensing device may tell whether or not the sensed data provides an enough relevance to the second query token if the second score of the relevance is greater than or equal to the second threshold; the sensing device may transmit at least one of the sensed data, the first sensing semantic or the first score of relevance if deciding the first score of relevance is high enough; the sensing device may transmit at least one of the sensed data, the second sensing semantic or the second score of relevance if deciding the second score of relevance is high enough.

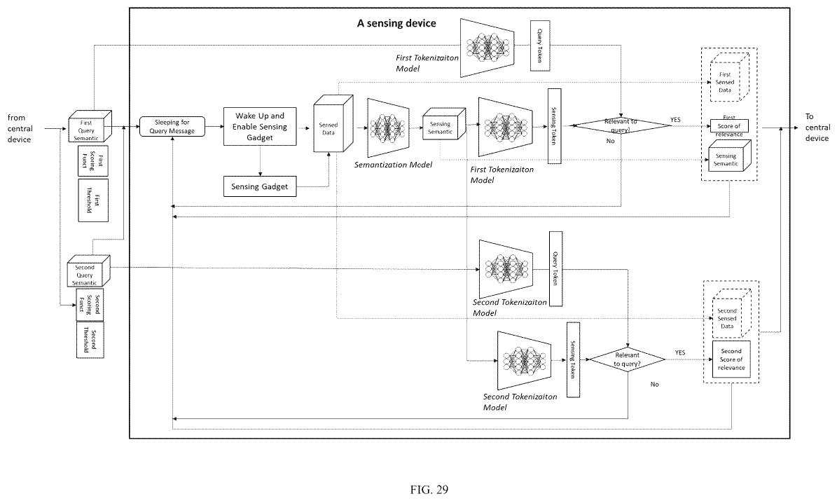

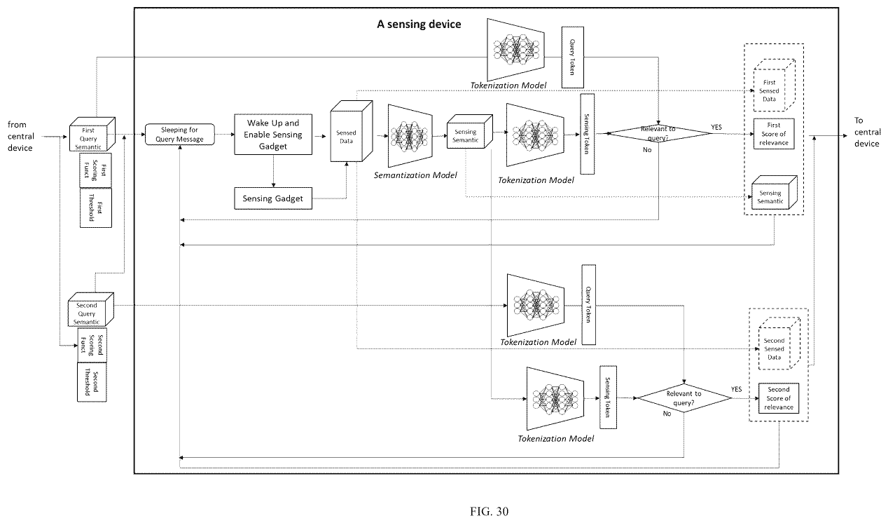

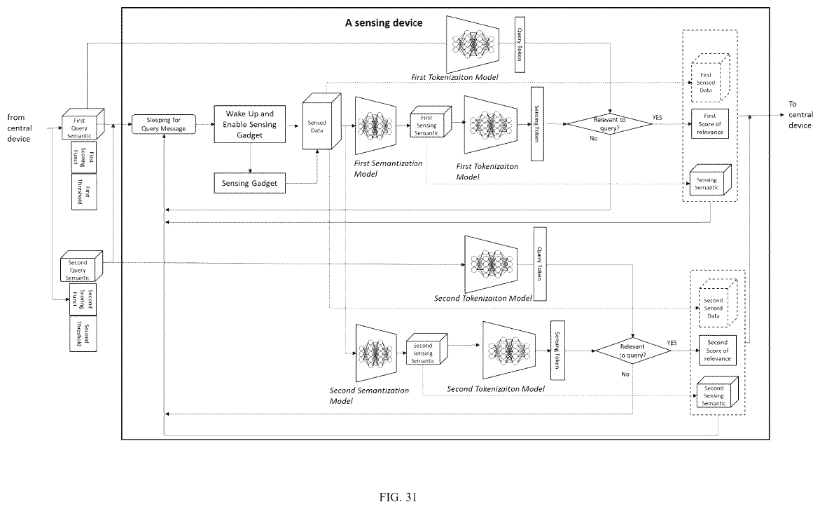

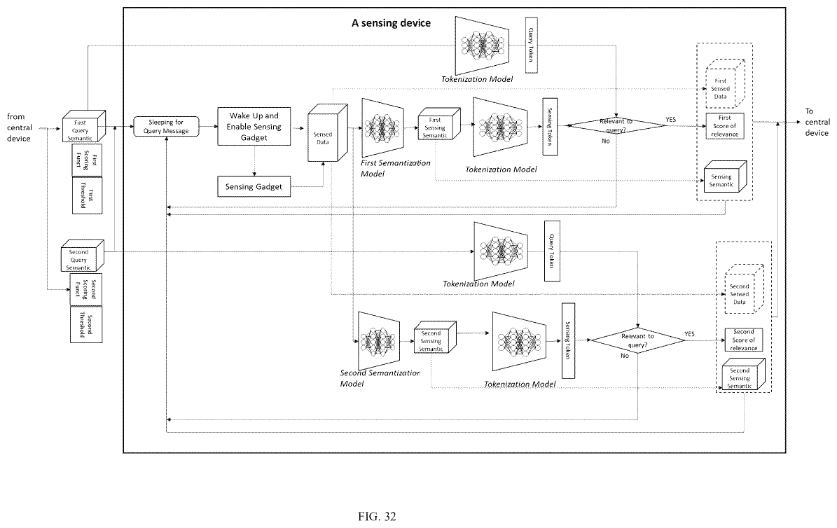

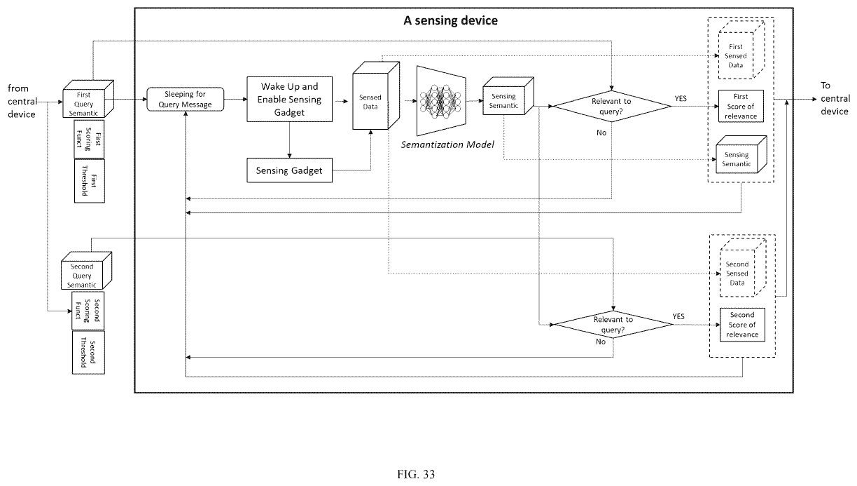

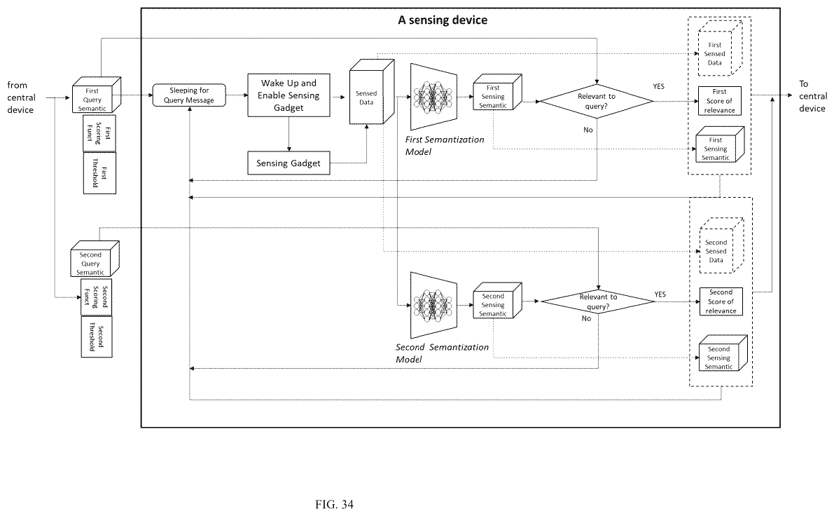

FIG. 29 is a schematic illustration of responding to two query semantics with a common semantization model and two different tokenization models, which shows how a sensing device responds to two query semantics with a common semantization model and two different tokenization models in a possible implementation. FIG. 30 is a schematic illustration of responding to two query semantics with a common semantization model and a common tokenization model, which shows how a sensing device responds to two query semantics with a common semantization model and a common tokenization model in a possible implementation. FIG. 31 is a schematic illustration of responding to two query semantics with two semantization models and two tokenization models, which shows how a sensing device responds to two query semantics with two semantization models and two tokenization models in a possible implementation. FIG. 32 is a schematic illustration of responding to two query semantics with two semantization models and one tokenization model, which shows how a sensing device responds to two query semantics with two semantization models and one tokenization model in a possible implementation. FIG. 33 is a schematic illustration of responding to two query semantics with one semantization model without tokenization model, which shows how a sensing device responds to two query semantics with one semantization model without tokenization model in a possible implementation. FIG. 34 is a schematic illustration of responding to two query semantics with two semantization models without tokenization model, which shows how a sensing device responds to two query semantics with two semantization models without tokenization model in a possible implementation.

A sensing device may receive both the first query semantic and the second query semantic and wakes to enable its sensing gadget to sense the physical-world around itself into a sensed data. There are several options shown as follows:
Alternative #1: the sensing device may convert the sensed data into one common sensing semantic by one LLM or LLMs; and then the sensing device may tokenize the sensing semantic into the first sensing token and the first query semantic into the first query token, both tokens of which are with the same first length that the sensing device decides, while the sensing device may tokenize the sensing semantic into the second sensing token and the second query semantic into the second query token, both tokens of which are with the same second length that the sensing device decides, wherein the sensing device may use the first tokenization model to tokenize the sensing semantic into the first sensing token and the second tokenization model to tokenize the sensing semantic into the second sensing token (FIG. 29), or may use a common tokenization model to tokenize the sensing semantic into both the first sensing token and the second sensing token (FIG. 30); the sensing device may score the relevance between the first query token and the first sensing token and the relevance between the second query token and the second sensing token; the sensing device may tell whether or not the sensed data provides an enough relevance to the first query token if the first score of the relevance is greater than or equal to the first threshold, and the sensing device may tell whether or not the sensed data provides an enough relevance to the second query token if the second score of the relevance is greater than or equal to the second threshold; the sensing device may transmit at least one of the sensed data, sensing semantic or the first score of relevance if deciding the first score of relevance is high enough; the sensing device may transmit at least one of the sensed data, sensing semantic or the second score of relevance if deciding the second score of relevance is high enough.
Alternative #2: the sensing device may convert the sensed data into the first sensing semantic by one LLM or LLMs and convert the same sensed data into the second sensing semantic by one LLM or LLMs; and tokenize the first sensing semantic into the first sensing token and the first query semantic into the first query token, both tokens of which are with the same first length that the sensing device decides, while the sensing device may tokenize the second sensing semantic into the second sensing token and the second query semantic into the second query token, both tokens of which are with the same second length that the sensing device decides, wherein the sensing device may use the first tokenization model to tokenize the first sensing semantic into the first sensing token and the second tokenization model to tokenize the second sensing semantic into the second sensing token (FIG. 31), or may use a common tokenization model (FIG. 32) to tokenize the first and second sensing semantics into both the first sensing token and the second sensing token; the sensing device may score the relevance between the first query token and the first sensing token and the relevance between the second query token and the second sensing token; the sensing device may tell whether or not the sensed data provides an enough relevance to the first query token if the first score of the relevance is greater than or equal to the first threshold, and the sensing device may tell whether or not the sensed data provides an enough relevance to the second query token if the second score of the relevance is greater than or equal to the second threshold; the sensing device may transmit at least one of the sensed data, the first sensing semantic or the first score of relevance if deciding the first score of relevance is high enough; the sensing device may transmit at least one of the sensed data, the second sensing semantic or the second score of relevance if deciding the second score of relevance is high enough.
Alternative #3 (FIG. 33): the sensing device may convert the sensed data into one common sensing semantic by one LLM or LLMs; and then the sensing device may score the relevance between the first query semantic and the sensing semantic and the relevance between the second query semantic and the sensing semantic; the sensing device may tell whether or not the sensed data provides an enough relevance to the first query semantic if the first score of the relevance is greater than or equal to the first threshold, and the sensing device may tell whether or not the sensed data provides an enough relevance to the second query semantic if the second score of the relevance is greater than or equal to the second threshold; the sensing device may transmit at least one of the sensed data, the sensing semantic or the first score of relevance if deciding the first score of relevance is high enough; the sensing device may transmit at least one of the sensed data, the sensing semantic or the second score of relevance if deciding the second score of relevance is high enough.
Alternative #4 (FIG. 34): the sensing device may convert the sensed data into the first sensing semantic by one LLM or LLMs and convert the same sensed data into the second sensing semantic by one LLM or LLMs; and then the sensing device may score the relevance between the first query semantic and the first sensing semantic and the relevance between the second query semantic and the second sensing semantic; the sensing device may tell whether or not the sensed data provides an enough relevance to the first query semantic if the first score of the relevance is greater than or equal to the first threshold, and the sensing device may tell whether or not the sensed data provides an enough relevance to the second query semantic if the second score of the relevance is greater than or equal to the second threshold; the sensing device may transmit at least one of the sensed data, the first sensing semantic or the first score of relevance if deciding the first score of relevance is high enough; the sensing device may transmit at least one of the sensed data, the second sensing semantic or the second score of relevance if deciding the second score of relevance is high enough.

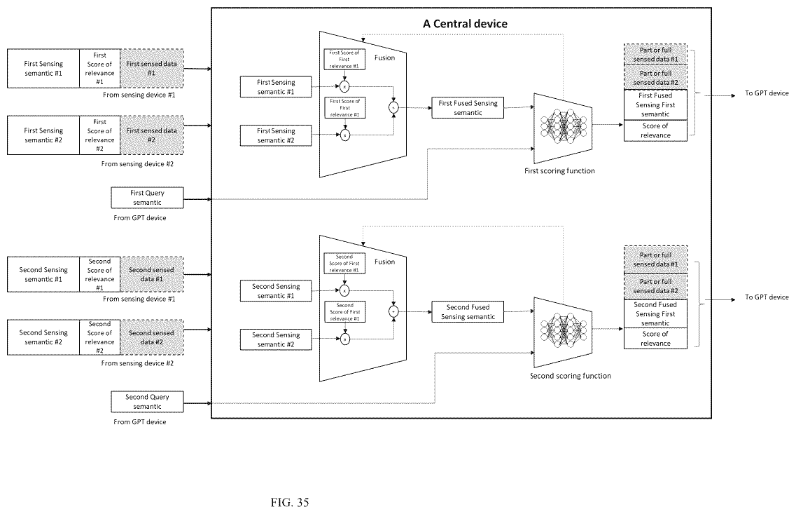

FIG. 35 is a schematic illustration of processing two sensing semantics independently, which shows how a central device processes the two sensing semantics independently in a possible implementation.

If the central device receives a number of the first sensing semantics plus the first scores of relevance and a number of the second sensing semantics plus the second scores of relevance, the central device may fuse these first sensing semantics according to their first scores of relevance into the first fused sensing semantic and the central device may fuse these second sensing semantics according to their second scores of relevance into the second fused sensing semantic; the central device may score the first fused sensing semantic by measuring the relevance between the first fused semantic and the first query semantic, and score the second fused sensing semantic by measuring the relevance between the second fused sensing semantic and the second query semantic; the central device may transmit the first fused sensing semantic with the first score of relevance to the first GPT device and transmit the second fused sensing semantic with the second score of relevance to the second GPT device; as shown in FIG. 35.

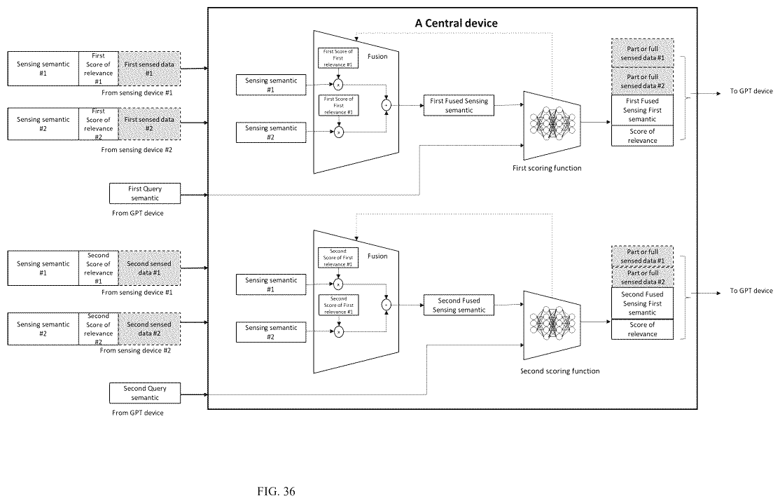

FIG. 36 is a schematic illustration of processing one sensing semantic but with two tasks independently, which shows how a central device processes the one sensing semantics but with two tasks independently in a possible implementation.

If the central device receives a number of the sensing semantics plus the first scores of relevance and the second scores of relevance, the central device may fuse these sensing semantics according to their first scores of relevance into the first fused sensing semantic and the central device may fuse the second sensing semantics according to their second scores of relevance into the second fused sensing semantic; the central device may score the first fused sensing semantic by measuring the relevance between the first fused semantic and the first query semantic, and score the second fused sensing semantic by measuring the relevance between the second fused sensing semantic and the second query semantic; the central device may transmit the first fused sensing semantic with the first score of relevance to the first GPT device and transmit the second fused sensing semantic with the second score of relevance to the second GPT device; as shown in FIG. 36.

The first GPT device may receive the first fused sensing semantic and the first score of relevance to the first query semantic; the first GPT device may de-semantize the first fused sensing semantic into the first sensing message; the first GPT device may input the first sensing message into the LLM(s) to inference to generate the next first query message; optionally, the first GPT device may input the first sensing message plus the first score of relevance to the LLM(s).

The second GPT device may receive the second fused sensing semantic and the second score of relevance to the second query semantic; the second GPT device may de-semantize the second fused sensing semantic into the second sensing message; the second GPT device may input the second sensing message into the LLM(s) to inference to generate the next second query message; optionally, the second GPT device may input the second sensing message plus the second score of relevance to the LLM(s).

Next, examples of products related to the methods for semantic communications will be described.

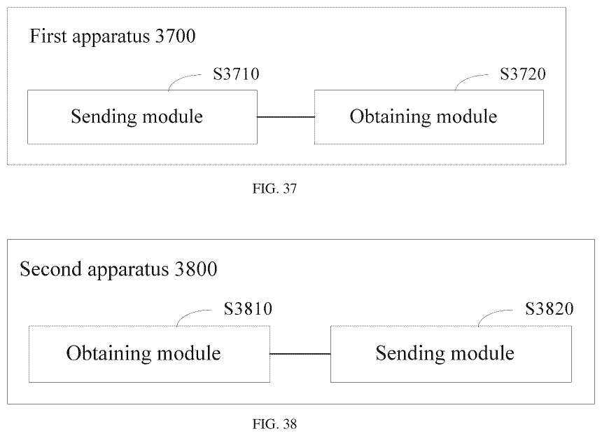

FIG. 37 is a schematic structural diagram of a first apparatus 3700 according to one or more example embodiments of the present disclosure.

As shown in FIG. 37, the first apparatus 3700 may include:
a sending module 3710, configured to send a first message, where the first message includes semantic capability information of the first apparatus; and
an obtaining module 3720, configured to obtain a second message sent based on the semantic capability information of the first apparatus.

In a possible implementation, the semantic capability information indicates semantic related capability information or token related capability information.

In a possible implementation, the semantic capability information indicates at least one of the following: whether a semantic capability is supported or not; a number of task types supported; a number of modality types supported; a query semantic level supported; a query semantic length supported; a query token level supported; a query token length supported; a sensing token length supported; a semantic model supported; a tokenization model supported; a tokenization function supported; or a scoring function supported, where the scoring function is used to score a relevance of a piece of sensed data and/or a relevance of a sensing semantic.

In a possible implementation, the semantic capability information includes a flag or one-bit indication indicating whether the first apparatus supports the semantic capability or not.

In a possible implementation, the semantic capability information includes at least one task identifier and/or at least one modality identifier, where each of the at least one task identifier indicates one task type supported by the first apparatus, and each of the at least one modality identifier indicates one modality type supported by the first apparatus.

In a possible implementation, the at least one task identifier and/or the at least one modality identifier is obtained from broadcast configuration of a second apparatus.

In a possible implementation, the at least one task identifier or the at least one modality identifier is carried in a synchronization signal and physical broadcast channel block (SSB) or a system information block (SIB).

In a possible implementation, the at least one task identifier or the at least one modality identifier is pre-configured.

In a possible implementation, the sending module 3710 is configured to: send the first message in a sequence.

In a possible implementation, the sending module 3710 is configured to: send the first message based on carrier aggregation.

In a possible implementation, the semantic capability information is semantized or tokenized.

In a possible implementation, the obtaining module 3720 is configured to: obtain a piece of query-related information multicast or unicast based on the semantic capability information of the first apparatus.

In a possible implementation, the piece of query-related information includes at least one query semantic and/or at least one query token.

In a possible implementation, a task type and/or a modality type for each of the at least one query semantic or for each of the at least one query token is supported by the first apparatus.

In a possible implementation, a query semantic level for each of the at least one query semantic or a query token level for each of the at least one query token is supported by the first apparatus.

In a possible implementation, a query semantic length for each of the at least one query semantic or a query token length for each of the at least one query token is supported by the first apparatus.

In a possible implementation, the sending module 3710 is further configured to: send a sensing result, where the sensing result includes at least one piece of sensed data and/or at least one sensing semantic.

In a possible implementation, a score of relevance of each piece of the at least one piece of sensed data is higher than a first threshold; and/or, a score of relevance of each of the at least one sensing semantic is higher than a second threshold.

In a possible implementation, the piece of query-related information includes at least one semantization model configuration, and the at least one semantization model configuration is supported by the first apparatus; or, the piece of query-related information includes a semantization model configuration update, and the semantization model configuration update includes update information for the first apparatus to update at least one outdated semantization model configuration to at least one updated semantization model configuration respectively, and the at least one updated semantization model configuration is supported by the first apparatus.

In a possible implementation, the piece of query-related information includes at least one approach for tokenization, and the at least one approach for tokenization is supported by the first apparatus.

In a possible implementation, each of the at least one approach for tokenization includes a tokenization model or a tokenization function.

In a possible implementation, the piece of query-related information includes at least one scoring function, and the at least one scoring function is supported by the first apparatus.

In a possible implementation, the obtaining module 3720 is configured to: obtain the second message which is intended for a group of first apparatuses that have same or qualified semantic capability, where the group of first apparatuses includes the first apparatus.

In a possible implementation, the second message includes paging information.

In a possible implementation, the first apparatus is a sensing apparatus.

The first apparatus may be applied to the above first device such as the sensing device as described in the above possible method implementations. It should be understood by a person skilled in the art that, the relevant description of the above modules in these possible implementations of the present disclosure may be understood with reference to the relevant description of the method for semantic communications in these possible implementations of the present disclosure. The technical effect achieved by the above first apparatus is similar as that achieved by the above possible method implementation, which is not repeated herein.

FIG. 38 is a schematic structural diagram of a second apparatus 3800 according to one or more example embodiments of the present disclosure.

As shown in FIG. 38, the second apparatus 3800 may include:
an obtaining module 3810, configured to obtain at least one first message, where each of the at least one first message includes semantic capability information of a respective one first apparatus of at least one first apparatus; and
a sending module 3820, configured to send at least one second message based on the semantic capability information of at least one third apparatus included in the at least one first apparatus.

In a possible implementation, the semantic capability information indicates semantic related capability information or token related capability information.

In a possible implementation, the semantic capability information indicates at least one of the following: whether a semantic capability is supported or not; a number of task types supported; a number of modality types supported; a query semantic level supported; a query semantic length supported; a query token level supported; a query token length supported; a sensing token length supported; a semantic model supported; a tokenization model supported; a tokenization function supported; or a scoring function supported, where the scoring function is used to score a relevance of a piece of sensed data and/or a relevance of a sensing semantic.

In a possible implementation, the semantic capability information includes a flag or one-bit indication indicating whether a first apparatus from which a first message including the semantic capability information is obtained supports the semantic capability or not.

In a possible implementation, the semantic capability information includes at least one task identifier and/or at least one modality identifier, where each of the at least one task identifier indicates one task type supported by a first apparatus from which a first message including the semantic capability information is obtained, and each of the at least one modality identifier indicates one modality type supported by the first apparatus from which the first message including the semantic capability information is obtained.

In a possible implementation, the at least one task identifier and/or the at least one modality identifier is obtained from broadcast configuration of the second apparatus.

In a possible implementation, the at least one task identifier or the at least one modality identifier is carried in a synchronization signal and physical broadcast channel block (SSB) or a system information block (SIB).

In a possible implementation, the at least one task identifier or the at least one modality identifier is pre-configured.

In a possible implementation, the obtaining module 3810 is configured to: obtain the at least one first message in a sequence.

In a possible implementation, the obtaining module 3810 is configured to: obtain the at least one first message sent based on carrier aggregation.

In a possible implementation, the semantic capability information is semantized or tokenized.

In a possible implementation, the sending module 3820 is configured to: multicast or unicast at least one piece of query-related information based on the semantic capability information of the at least one third apparatus.

In a possible implementation, each piece of query-related information of the at least one piece of query-related information includes at least one query semantic and/or at least one query token.

In a possible implementation, a task type and/or a modality type for each of the at least one query semantic or for each of the at least one query token is supported by a third apparatus to which the each piece of query-related information is multicast or unicast.

In a possible implementation, a query semantic level for each of the at least one query semantic or a query token level for each of the at least one query token is supported by a third apparatus to which the each piece of query-related information is multicast or unicast.

In a possible implementation, a query semantic length for each of the at least one query semantic or a query token length for each of the at least one query token is supported by a third apparatus to which the each piece of query-related information is multicast or unicast.

In a possible implementation, the obtaining module 3810 is further configured to: obtain a sensing result, where the sensing result includes at least one piece of sensed data and/or at least one sensing semantic.

In a possible implementation, a score of relevance of each piece of the at least one piece of sensed data is higher than a first threshold; and/or, a score of relevance of each of the at least one sensing semantic is higher than a second threshold.

In a possible implementation, each piece of query-related information of the at least one piece of query-related information includes at least one semantization model configuration, and the at least one semantization model configuration is supported by a third apparatus to which the each piece of query-related information is multicast or unicast; or, each piece of query-related information of the at least one piece of query-related information includes a semantization model configuration update, and the semantization model configuration update includes update information for a third apparatus to which the each piece of query-related information is multicast or unicast to update at least one outdated semantization model configuration to at least one updated semantization model configuration respectively, and the at least one updated semantization model configuration is supported by the third apparatus to which the each piece of query-related information is multicast or unicast.

In a possible implementation, each piece of query-related information of the at least one piece of query-related information includes at least one approach for tokenization, and the at least one approach for tokenization is supported by a third apparatus to which the each piece of query-related information is multicast or unicast.

In a possible implementation, each of the at least one approach for tokenization includes a tokenization model or a tokenization function.

In a possible implementation, each piece of query-related information of the at least one piece of query-related information includes at least one scoring function, and the at least one scoring function is supported by a third apparatus to which the each piece of query-related information is multicast or unicast.

In a possible implementation, the sending module 3820 is configured to: send the at least one second message which is intended for a group of sensing apparatuses that have same or qualified semantic capability, where the group of sensing apparatuses includes the at least one third apparatus.

In a possible implementation, the at least one second message includes paging information.

In a possible implementation, the first apparatus is a sensing apparatus.

The second apparatus may be applied to the above second device such as the central device as described in the above possible method implementations. It should be understood by a person skilled in the art that, the relevant description of the above modules in these possible implementations of the present disclosure may be understood with reference to the relevant description of the method for semantic communications in these possible implementations of the present disclosure. The technical effect achieved by the above second apparatus is similar as that achieved by the above possible method implementations, which is not repeated herein.

A possible implementation of the present disclosure provides a third apparatus including a processing circuitry for executing any of the above corresponding methods for semantic communications at the first device side, which is not repeated herein.

A possible implementation of the present disclosure provides a fourth apparatus including a processing circuitry for executing any of the above corresponding methods for semantic communications at the second device side, which is not repeated herein.

A possible implementation of the present disclosure provides a wireless communication system which includes: at least one first apparatus for executing any of the above corresponding methods for semantic communications at the first device side or at least one third apparatus for executing any of the above corresponding methods for semantic communications at the first device side; at least one second apparatus for executing any of the above corresponding methods for semantic communications at the second device side or at least one fourth apparatus for executing any of the above corresponding methods for semantic communications at the second device side; and at least one fifth apparatus, where each of the at least one fifth apparatus includes a sending module configured to send at least one query message to the at least one second apparatus and an obtaining module configured to obtain at least one fused sensing result sent by the at least one second apparatus, where the at least one fused sensing result is generated based on one or more sensing results. The above method is not repeated herein.

A possible implementation of the present disclosure provides a wireless communication system which includes: a first processing circuitry for executing any of the above corresponding methods for semantic communications at the first device side; a second processing circuitry for executing any of the above corresponding methods for semantic communications at the second device side; and a third processing circuitry for executing following steps: sending at least one query message to the second processing circuitry; and obtaining at least one fused sensing result sent by the second processing circuitry, where the at least one fused sensing result is generated based on one or more first sensing results. The above method is not repeated herein.

A possible implementation of the present disclosure provides a computer-readable medium storing computer execution instructions which, when executed by a processor, cause the processor to execute any of the above methods for semantic communications, which is not repeated herein.

A possible implementation of the present disclosure provides a computer program product including computer execution instructions which, when executed by a processor, cause the processor to execute any of the above methods for semantic communications, which is not repeated herein.

A method, apparatus and system for semantic capability indication is provided in the present disclosure.

Some aspects of the present disclosure relate to a scheme of a semantic-based communication to manage and schedule a large number of sensing devices, in which the sensing devices may belong to different types. The query semantics are goal-oriented and only the sensing device whose sensed data has sufficient relevance with the semantic message(s) would response and transmit their sensed data that are preferably in semantic form too.

Some aspects of the present disclosure relate to a scheme of a collective semantic token-based scheduling over a large number of sensing devices rather than one-to-one individual scheduling.

Some aspects of the present disclosure relate to a scheme of using the large-Language-model (LLM) to turn query and sensed data into a common semantic domain on which they can be easily compared to each other and fused.

The above one or more aspects of the present disclosure may have at least one of the following benefits:
scheduling may be task-oriented or goal-oriented; only the sensing devices that has contributions to a scheduled task or goal will response and transmit their sensed data;
privacy may be protected: both the task, goal, or query and sensed data are well protected; no raw data or minimum raw data or message is transmitted over the air;
forward compatible: semantic-based sensing system in this disclosure may be forward compatible in a sense that any new sensing mechanism can be supported.

In some aspects of the present disclosure, there is provided a computer program including instructions. The instructions, when executed by a processor, may cause the processor to implement the method of the present disclosure.

In some aspects of the present disclosure, there is provided a non-transitory computer-readable medium storing instructions, the instructions, when executed by a processor, may cause the processor to implement the method of the present disclosure.

In some aspects of the present disclosure, there is provided an apparatus/chipset system including means to implement the method implemented by the sensing device of the present disclosure.

In some aspects of the present disclosure, there is provided an apparatus/chipset system including means to implement the method implemented by the central device of the present disclosure.

In some aspects of the present disclosure, there is provided an apparatus/chipset system including means to implement the method implemented by the GPT device of the present disclosure.

In some aspects of the present disclosure, there is provided a system comprising at least two of an apparatus in the sensing device of the present disclosure, an apparatus in the central device of the present disclosure and an apparatus in the GPT device of the present disclosure.

In some aspects of the present disclosure, there is provided an apparatus/chipset system including at least one processor executing instructions stored in a computer-readable medium to implement the method implemented by the sensing device of the present disclosure.

In some aspects of the present disclosure, there is provided an apparatus/chipset system including at least one processor executing instructions stored in a computer-readable medium to implement the method implemented by the central device of the present disclosure.

In some aspects of the present disclosure, there is provided an apparatus/chipset system including at least one processor executing instructions stored in a computer-readable medium to implement the method implemented by the GPT device of the present disclosure.

### Example Concepts of Some Terms

Message: a payload in a natural language, e.g., English, French, or Chinese;
Query message: a query sentence in a natural language;
Sensing message: a description about an observation or sensed data in a natural language;
Semantic: a vector, a matrix, a tensor of scalars to embed a message;
Query semantic: a semantic that embeds a query message;
Sensing semantic: a semantic that embeds a sensing message;
Token: a vector of scalars encoded from a semantic;
Query token: a token that is encoded from a query semantic;
Sensing token: a token that is encoded from a sensing semantic;
GPT device: a device that runs over generative AI model or models to generate one query message or messages given a sensing message or messages;
Central device: a device as BS that connects a plurality of terminal devices via radio access in DL and UL, and connects with the core network via backbone network;
Sensing device: a device as terminal that connects to one BS or BSs and that is equipped with the sensing gadget to measure data of interest near it.

Please note that the different embodiments may be implemented separately or combined. Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

All values and sub-ranges within disclosed ranges are also disclosed. Also, although the systems, devices and processes disclosed and shown herein may include a specific number of elements/components, the systems, devices and assemblies could be modified to include additional or fewer of such elements/components. For example, although any of the elements/components disclosed may be referenced as being singular, the possible implementations disclosed herein could be modified to include a plurality of such elements/components. The subject matter described herein intends to cover and embrace all suitable changes in technology.

1. A method, comprising:
sending a first message, wherein the first message comprises semantic capability information of a first device; and
obtaining a second message sent based on the semantic capability information of the first device.

2. The method according to claim 1, wherein the semantic capability information indicates semantic related capability information or token related capability information.

3. The method according to claim 1, wherein the semantic capability information indicates at least one of:
whether a semantic capability is supported or not;
a number of task types supported;
a number of modality types supported;
a query semantic level supported;
a query semantic length supported;
a query token level supported;
a query token length supported;
a sensing token length supported;
a semantic model supported;
a tokenization model supported;
a tokenization function supported; or
a scoring function supported, wherein the scoring function is used to score at least one of a relevance of a piece of sensed data or a relevance of a sensing semantic.

4. The method according to claim 3, wherein the semantic capability information comprises a flag or a one-bit indication indicating whether the first device supports the semantic capability.

5. The method according to claim 3, wherein the semantic capability information comprises at least one of at least one task identifier or at least one modality identifier, wherein each task identifier of the at least one task identifier indicates a respective task type supported by the first device, and wherein each modality identifier of the at least one modality identifier indicates a respective modality type supported by the first device.

6. The method according to claim 5, wherein the at least one of the at least one task identifier or the at least one modality identifier is obtained from broadcast configuration of a second device.

7. A first apparatus, comprising:
at least one processor coupled to a memory storing instructions, wherein when the instructions are executed by the at least one processor, the first apparatus is caused to:
send a first message, wherein the first message comprises semantic capability information of the first apparatus; and
obtain a second message sent based on the semantic capability information of the first apparatus.

8. The first apparatus according to claim 7, wherein the semantic capability information indicates semantic related capability information or token related capability information.

9. The first apparatus according to claim 7, wherein the semantic capability information indicates at least one of:
whether a semantic capability is supported or not;
a number of task types supported;
a number of modality types supported;
a query semantic level supported;
a query semantic length supported;
a query token level supported;
a query token length supported;
a sensing token length supported;
a semantic model supported;
a tokenization model supported;
a tokenization function supported; or
a scoring function supported, wherein the scoring function is used to score at least one of a relevance of a piece of sensed data or a relevance of a sensing semantic.

10. The first apparatus according to claim 9, wherein the semantic capability information comprises a flag or a one-bit indication indicating whether the first apparatus supports the semantic capability.

11. The first apparatus according to claim 9, wherein the semantic capability information comprises at least one of at least one task identifier or at least one modality identifier, wherein each task identifier of the at least one task identifier indicates a respective task type supported by the first apparatus, and wherein each modality identifier of the at least one modality identifier indicates a respective modality type supported by the first apparatus.

12. The first apparatus according to claim 11, wherein the at least one of the at least one task identifier or the at least one modality identifier is obtained from broadcast configuration of a second apparatus.

13. The first apparatus according to claim 12, wherein the at least one task identifier or the at least one modality identifier is carried in a synchronization signal and physical broadcast channel block (SSB) or a system information block (SIB).

14. A second apparatus, comprising:
at least one processor coupled to a memory storing instructions, wherein when the instructions are executed by the at least one processor, the second apparatus is caused to:
obtain at least one first message, wherein each message of the at least one first message comprises respective semantic capability information of a respective first apparatus of at least one first apparatus; and
send at least one second message based on semantic capability information of one or more apparatuses of the at least one first apparatus.

15. The second apparatus according to claim 14, wherein the semantic capability information indicates semantic related capability information or token related capability information.

16. The second apparatus according to claim 14, wherein the semantic capability information indicates at least one of:
whether a semantic capability is supported or not;
a number of task types supported;
a number of modality types supported;
a query semantic level supported;
a query semantic length supported;
a query token level supported;
a query token length supported;
a sensing token length supported;
a semantic model supported;
a tokenization model supported;
a tokenization function supported; or
a scoring function supported, wherein the scoring function is used to score at least one of a relevance of a piece of sensed data or a relevance of a sensing semantic.

17. The second apparatus according to claim 16, wherein the semantic capability information comprises a flag or a one-bit indication indicating whether a first apparatus, from which a first message comprising the semantic capability information is obtained, supports the semantic capability.

18. The second apparatus according to claim 16, wherein the semantic capability information comprises at least one of at least one task identifier or at least one modality identifier, wherein each task identifier of the at least one task identifier indicates a respective task type supported by a first apparatus from which a first message comprising the semantic capability information is obtained, and wherein each modality identifier of the at least one modality identifier indicates a respective modality type supported by the first apparatus.

19. The second apparatus according to claim 18, wherein the at least one of the at least one task identifier or the at least one modality identifier is included in broadcast configuration sent to the at least one first apparatus.

20. The second apparatus according to claim 19, wherein the at least one task identifier or the at least one modality identifier is carried in a synchronization signal and physical broadcast channel block (SSB) or a system information block (SIB).
